(19) United States
(12) Patent Application Publication
(10) Pub. No.: US 2026/0274122 A1
(43) Pub. Date: Sep. 17, 2026

(54) CROTCH BELT LENGTH ADJUSTING DEVICE, WAIST BELT DISTANCE ADJUSTING DEVICE AND CHILD CARRIER

(71) Applicant: WONDERLAND SWITZERLAND AG, Steinhausen (CH)

(72) Inventors: Jiajun LIANG, Dongguan (CN); Daliang ZHANG, Dongguan (CN); Ruyi LI, Dongguan (CN); Ganqing FANG, Dongguan (CN)

(21) Appl. No.: 19/166,194

(22) PCT Filed: Mar. 18, 2024
(86) PCT No.: PCT/IB2024/000148

§ 371 Date: Sep. 17, 2025

(30) Foreign Application Priority Data
Mar. 17, 2023 (CN) 202310268547.9
May 22, 2023 (CN) 202310583172.5
Jun. 8, 2023 (CN) 202310679440.3
Jul. 6, 2023 (CN) 202310827253.5
Mar. 1, 2024 (CN) 202410239315.5

(51) Int. Cl. B60N 2/28

(52) U.S. Cl. CPC B60N 2/2816; B60N 2/2812

(57) ABSTRACT

The present disclosure provides a crotch belt length adjusting device for a child carrier, a waist belt distance adjusting device and a child carrier, wherein the crotch belt length adjusting device includes: a crotch belt having a first end and a second end, with the first end of the crotch belt being connected to a seat part of the child carrier; and an adjustment hole and a plurality of second holes both formed penetrating through the seat part, with the second end of the crotch belt being passing through the adjustment hole, and then passing through one of the second holes from the lower surface to be exposed on the upper surface, and a portion of the second end exposed on the upper surface being provided with a second end obstruction member, and the second end obstruction member being arranged as unable to pass through the second hole.

### CROSS-REFERENCE TO RELATED APPLICATIONS

This application is a National Stage application of PCT/IB2024/000148, entitled “CROTCH BELT LENGTH ADJUSTING DEVICE, WAIST BELT DISTANCE ADJUSTING DEVICE AND CHILD CARRIER” and filed on Mar. 18, 2024, which claims the benefit of Chinese Applications No. 202310268547.9, filed on Mar. 17, 2023, No. 202310583172.5, filed on May 22, 2023, No. 202310679440.3, filed on Jun. 8, 2023, No. 202310827253.5, filed on Jul. 6, 2023, No. 202410239315.5, filed on Mar. 1, 2024, both of which are incorporated herein by reference in their entirety.

### TECHNICAL FIELD

The present disclosure relates to a child carrier and, more particularly, to a crotch belt length adjusting device and a waist belt distance adjusting device of a child carrier.

### BACKGROUND

A child carrier is generally designed in multi-level mode, so as to be suitable for children of different sizes. Meanwhile, in order to adapt to the use of children of different sizes, the lengths, heights and distances of crotch belts and waist belts should be designed in an adjustable mode.

### SUMMARY

As embodied and generally described here, the disclosure provides a crotch belt length adjusting device for a child carrier, which comprises: a crotch belt having a first end and a second end, with the first end of the crotch belt being connected to a seat part of the child carrier; and an adjustment hole and a plurality of second holes both formed penetrating through the seat part, with the second end of the crotch belt being passing through the adjustment hole from an upper surface of the seat part to a lower surface of the seat part, and then passing through one of the second holes from the lower surface to be exposed on the upper surface, and a portion of the second end exposed on the upper surface being provided with a second end obstruction member, and the second end obstruction member being arranged as unable to pass through the second hole.

In an embodiment, the crotch belt length adjusting device further comprises: a first hole formed penetrating through the seat part, with the first end of the crotch belt passing through the first hole from the upper surface of the seat part to be exposed on the lower surface of the seat part, and a portion of the first end exposed on the lower surface being provided with a first end obstruction member, and the first end obstruction member being arranged as unable to pass through the first hole.

In an embodiment, the first end obstruction member and the second end obstruction member are both frame buckles with a middle cross bar.

In an embodiment, a limiting rib is formed around each of the second holes on the upper surface of the seat part, and contours of the limiting ribs are each corresponding to the shape of the second end obstruction member.

In an embodiment, the second holes and the adjustment hole are elongated holes, and their extending directions are parallel to each other and perpendicular to a width direction of the seat part.

In an embodiment, the second holes and the adjustment hole are arranged side by side and at intervals along a width direction of the seat part.

In an embodiment, a spacing distance between two adjacent second holes is 40 mm.

In an embodiment, the second holes are communicated with each other through a connecting hole formed penetrating through the seat part, and the connecting hole is arranged as an elongated hole and extends in a direction intersecting with an extending direction of the second holes.

In an embodiment, the connecting hole is arranged to extend in a direction perpendicular to the extending directions of the second holes.

In an embodiment, the plurality of second holes is two or three second holes, such that length of a used section of the crotch belt is able to be adjusted between two adjusting positions or three adjusting positions.

In an embodiment, the seat part is provided with a removable cushion, and the cushion covers the upper surface of the seat part.

In an embodiment, the second end obstruction member is arranged to have a thickness greater than a width of each of the second holes and greater than a width of the connecting hole.

In an embodiment, the second end obstruction member is arranged to have a thickness greater than a width of each of the second holes.

In an embodiment, the second holes are communicated with each other through a connecting hole formed penetrating through the seat part, and the second end obstruction member is arranged to have a thickness greater than a width of the connecting hole.

In an embodiment, a portion of the second end of the crotch belt exposed on the upper surface forms a multi-layer folding structure, and the second end obstruction member is arranged on the multi-layer folding structure, such that a sum of thicknesses of the second end obstruction member and the multi-layer folding structure is greater than a width of each of the second holes and greater than a width of the connecting hole.

In an embodiment, a thickness of the multi-layer folding structure is greater than the width of the second holes and greater than the width of the connecting hole.

In an embodiment, a portion of the second end of the crotch belt exposed on the upper surface forms a multi-layer folding structure, and the second end obstruction member is arranged on the multi-layer folding structure, such that a sum of thicknesses of the second end obstruction member and the multi-layer folding structure is greater than a width of each of the second holes.

In an embodiment, the thickness of the multi-layer folding structure is greater than width of each of the second holes.

In an embodiment, the second holes are communicated with each other through a connecting hole formed penetrating through the seat part, a portion of the second end of the crotch belt exposed on the upper surface forms a multi-layer folding structure, and the second end obstruction member is arranged on the multi-layer folding structure, such that a sum of thicknesses of the second end obstruction member and the multi-layer folding structure is greater than a width of the connecting hole.

In an embodiment, the thickness of the multi-layer folding structure is greater than the width of the connecting hole.

In an embodiment, the multi-layer folding structure is a bowknot.

In an embodiment, the multi-layer folding structure is provided with at least one wing part.

In an embodiment, the second end obstruction member has at least one second end obstruction member penetrating slot, and the least one wing part is arranged to pass through the second end obstruction member penetrating slot.

In an embodiment, a portion of the crotch belt adjacent to the first end is provided with a first end stop structure, and the first end stop structure is positioned above the upper surface of the seat part and is arranged unable to pass through the first hole.

In an embodiment, the first end obstruction member has at least one first end obstruction member penetrating slot, and the first end stop structure is formed by the first end of the crotch belt passing through first hole and the first end obstruction member penetrating slot successively from upper surface the of the seat part, and then reversely passing through the first hole to reach above the upper surface of the seat part, and being connected with other part of the crotch belt located above the upper surface of the seat part.

In an embodiment, the first end stop structure is formed as a half bowknot with a wing part larger than the first hole in size, and a free end of the half bowknot is arranged to abut against the upper surface of the seat part.

In another solution, the disclosure provides a crotch belt length adjusting device for a child carrier, which comprises: a crotch belt having a first end and a second end, with the first end being connected to a seat part of the child carrier; and an adjustment hole and a plurality of second holes both formed penetrating through the seat part, with the crotch belt being passing through the adjustment hole, and the second end of the crotch belt being arranged to be one-way removably fixed to one of the second holes.

In an embodiment, the second end of the crotch belt is arranged to be upward removably fixed to one of the second holes.

In an embodiment, the first end of the crotch belt is arranged to be one-way removably fixed to the seat part.

In an embodiment, the first end of the crotch belt is arranged to be downward removably fixed to the seat part.

In an embodiment, the second holes and the adjustment hole are elongated holes, and their extending directions are parallel to each other and perpendicular to a width direction of the seat part.

In an embodiment, the second holes and the adjustment hole are arranged side by side and at intervals along a width direction of the seat part.

In an embodiment, a spacing distance between two adjacent second holes is 40 mm.

In an embodiment, the second holes are communicated with each other through a connecting hole formed penetrating through the seat part, and the connecting hole is arranged as an elongated hole and extends in a direction intersecting with an extending direction of the second holes.

In an embodiment, the connecting hole is arranged to extend in a direction perpendicular to the extending directions of the second holes.

In an embodiment, the plurality of second holes is two or three second holes, such that length of a used section of the crotch belt is able to be adjusted between two adjusting positions or three adjusting positions.

In yet another solution, the disclosure provides a crotch belt length adjusting device for a child carrier, which comprises: a crotch belt having a first end and a second end, with the first end of the crotch belt being connected to a seat part of the child carrier; and a plurality of second holes formed penetrating through the seat part, wherein the second end of the crotch belt passes through one of the second holes from a lower surface of the seat part to be exposed on an upper surface of the seat part.

In an embodiment, the crotch belt length adjusting device further comprises: a first hole formed penetrating through the seat part, with the first end of the crotch belt being passing through the first hole from the lower surface of the seat part to be exposed on the upper surface of the seat part, and a portion of the first end exposed on the upper surface being provided with a first end obstruction member, and the first end obstruction member being arranged to have a length and a width both larger than a width of the first hole.

In an embodiment, the first hole and the second holes are elongated holes, and their extending directions are parallel to each other and parallel to a width direction of the seat part In an embodiment, the second holes are arranged side by side and at intervals along a direction perpendicular to the width direction of the seat part.

In an embodiment, the second holes are communicated with each other through a connecting hole formed penetrating through the seat part, and the connecting hole is arranged as an elongated hole and extends in a direction intersecting with extending directions of the second holes.

In an embodiment, the connecting hole is arranged to extend in a direction perpendicular to the extending directions of the second holes.

In an embodiment, the first end obstruction member is arranged such that a sum of its thickness and a thickness of the crotch belt is equal to or smaller than widths of the first hole and equal to or smaller than a width of each of the second holes.

In an embodiment, the child carrier includes a safety belt, and the safety belt is provided with a connecting clasp; and a portion of the crotch belt exposed on the upper surface of the seat part is provided with a buckle, and the buckle is for being engaged with the connecting clasp.

In another solution, the disclosure provides a crotch belt length adjusting device for a child carrier, which comprises: a crotch belt; and a plurality of second holes formed penetrating through a seat part of the child carrier, wherein the crotch belt is arranged to pass through one of the second holes, such that the crotch belt includes a hidden section located below a lower surface of the seat part and an exposed section located above an upper surface of the seat part, and a used length of the exposed section is able to be changed by passing the crotch belt through different second holes.

In an embodiment, the crotch belt has a first end and a second end, the first end is an end of the hidden section and is connected to the lower surface of the seat part of the child carrier, and the second end is an end of the exposed section.

In an embodiment, the crotch belt has a first end and a second end, the first end extends from an end of the hidden section, and the second end is an end of the exposed section, and the crotch belt length adjusting device further comprises a first hole formed penetrating through the seat part, the first end of the crotch belt passes through the first hole from the lower surface of the seat part to exposed on the upper surface of the seat part, a portion of the first end exposed on the upper surface is provided with a first end obstruction member, and the first end obstruction member is arranged to have a length and a width both larger than a width of the first hole.

In an embodiment, the first hole and the second holes are elongated holes, and their extending directions are parallel to each other and parallel to a width direction of the seat part, and the second holes are arranged side by side and at intervals along a direction perpendicular to the width direction of the seat part.

In an embodiment, the second holes are communicated with each other through a connecting hole formed penetrating through the seat part, and the connecting hole is arranged as an elongated hole and extends in a direction intersecting with extending directions of the second holes.

In an embodiment, the connecting hole is arranged to extend in a direction perpendicular to the extending directions of the second holes.

In an embodiment, the first end obstruction member is arranged such that a sum of its thickness and a thickness of the crotch belt is equal to or smaller than the width of the first hole and equal to or smaller than a width of each of the second holes.

In an embodiment, the child carrier includes a safety belt, and the safety belt is provided with a connecting clasp; and the exposed section of the crotch belt is provided with a buckle, and the buckle is for being engaged with the connecting clasp.

In yet another solution, the disclosure provides a waist belt distance adjusting device for a child carrier including a seat part and a backrest part at an angle in respect to the seat part, wherein the waist belt distance adjusting device comprises: two safety belts, each has a first end and a second end, and the first ends of the safety belts are connected to the backrest part, and at least one set of waist belt adjustment slots, each set of the waist belt adjustment slots includes a plurality of waist belt adjustment slots, and the waist belt adjustment slots are formed penetrating through the seat part, wherein the second end of one of the two safety belts passes through one waist belt adjustment slot in one set of waist belt adjustment slots from the upper surface of the seat part to the lower surface of the seat part, and a portion of the second end of one of the two safety belts exposed on the lower surface is provided with a waist belt obstruction member, and the waist belt obstruction member is arranged to have a length and a width both larger than a width of the waist belt adjustment slot, and the second end of the other one of the two safety belts is movably or fixedly connected to the seat part.

In an embodiment, the waist belt obstruction member is arranged such that a sum of its thickness and a thickness of the safety belt is equal to or smaller than the width of the waist belt adjustment slot.

In an embodiment, wherein the waist belt distance adjusting device comprises another set of waist belt adjustment slots, wherein the second end of the other one of the two safety belts passes through one waist belt adjustment slot in the another set of waist belt adjustment slots from the upper surface of the seat part to the lower surface of the seat part, and a portion of the second end of the other one of the two safety belts exposed on the lower surface is provided with the another waist belt obstruction member, and another waist belt obstruction member is arranged to have a length and a width both larger than a width of the waist belt adjustment slot in the another set of waist belt adjustment slots.

In an embodiment, the another waist belt obstruction member is arranged such that a sum of its thickness and a thickness of the other one safety belt is equal to or smaller than the width of the waist belt adjustment slot in the another set of waist belt adjustment slots.

In an embodiment, the one set of waist belt adjustment slots and the another set of waist belt adjustment slots are arranged on both sides of the seat part along a width direction of the child carrier.

In an embodiment, the waist belt adjustment slots are elongated holes, and their extending directions are parallel to each other and perpendicular to the width direction of the seat part, the waist belt adjustment slots in the one set of waist belt adjustment slots are arranged side by side and at intervals along the width direction of the seat part, and the waist belt adjustment slots in the another set of waist belt adjustment slots are arranged side by side and at intervals along the width direction of the seat part.

In an embodiment, the waist belt adjustment slots in the at least one set of waist belt adjustment slots are communicated with each other through a waist belt connecting slot formed penetrating through the seat part, and the waist belt connecting slot is arranged as an elongated slot and extends in a direction intersecting with the extending directions of the waist belt adjustment slot.

In an embodiment, the waist belt connecting slot is arranged to extend in a direction perpendicular to the extending directions of the waist belt adjustment slots.

In an embodiment, the waist belt distance adjusting device comprises a waist belt limiting structure, and the waist belt limiting structure is arranged for limiting movement of the waist belt obstruction member in respect to the lower surface of the seat part.

In an embodiment, the waist belt limiting structure is an obstruction member engaging structure on the lower surface of the seat part, the obstruction member engaging structure is one or more elastic fingers shaped protruded, and arranged around the waist belt adjustment slot for engaging with an edge of the waist belt obstruction member.

In an embodiment, the waist belt obstruction member has at least one waist belt obstruction member penetrating slot, and the waist belt limiting structure is formed by the second end of the safety belt sequentially passing through the waist belt adjustment slot and the waist belt obstruction member penetrating slot from the upper surface of the seat part, and then reversibly passing through the waist belt adjustment slot to return to above the upper surface of the seat part, and being connected to other part of the safety belt above the upper surface of the seat part.

In an embodiment, the waist belt limiting structure is formed as a half bowknot with one wing part and larger than the waist belt adjustment slots in size, and a free end of the half bowknot is arranged to abut against the upper surface of the seat part.

In an embodiment, the child carrier comprises a crotch belt, and the crotch belt is provided with a buckle; and a connecting clasp is disposed between the first end and the second end of the safety belt, and the connecting clasp is for being engaged with the buckle.

In another solution, the disclosure provides a child carrier, wherein the child carrier comprises one or both of the crotch belt length adjusting device mentioned above and the waist belt distance adjusting device mentioned above.

The foregoing and other objects, features, aspects and advantages of the present disclosure will become more apparent from the following detailed description of the disclosure taken in conjunction with the accompanying drawings.

### BRIEF DESCRIPTION OF THE DRAWINGS

Accompanying drawings are included to provide a further understanding of the disclosure and are incorporated in and constitute a part of this specification, which illustrate embodiments of the disclosure and together with the description below serve to explain the concept of the disclosure.

In the drawings:

FIG. 1 is a schematic front view of a child carrier adopting a first embodiment of the crotch belt length adjusting device according to the disclosure, in which there are three second holes, and a second end of the crotch belt is located at a second hole at first adjusting position.

FIG. 2 is a front partial sectional view and partial enlarged view of the child carrier shown in FIG. 1.

FIG. 3 is a schematic front view of the child carrier shown in FIG. 1, in which the second end of the crotch belt is located at a second hole at second adjusting position.

FIG. 4 is a front partial sectional view and partial enlarged view of the child carrier shown in FIG. 3.

FIG. 5 is a schematic front view of the child carrier shown in FIG. 1, in which the second end of the crotch belt is located at second hole at third adjusting position.

FIG. 6 is a front partial sectional view and partial enlarged view of the child carrier shown in FIG. 5.

FIG. 7 is a schematic front view of the child carrier shown in FIG. 1, in which the crotch belt is removed.

FIG. 8 is a partial top view of the child carrier shown in FIG. 7.

FIG. 9 is a front partial schematic view of a child carrier adopting another embodiment of the crotch belt length adjusting device according to the disclosure, in which there are two second holes, and the second end of the crotch belt is located at the second hole at first adjusting position.

FIG. 10 is a front partial sectional view of the child carrier shown in FIG. 9.

FIG. 11 is a front partial schematic view of the child carrier shown in FIG. 9, in which the second end of the crotch belt is located at the second hole at second adjusting position.

FIG. 12 is a front partial sectional view of the child carrier shown in FIG. 11.

FIG. 13 is a front partial schematic view of the child carrier shown in FIG. 9, in which the crotch belt is removed.

FIG. 14 is a partial top view of the child carrier shown in FIG. 13.

FIGS. 15A and 15B are schematic views of a frame buckle with a middle cross bar of the crotch belt length adjusting device according to the disclosure.

FIG. 16 is a front partial sectional view of the child carrier adopting an embodiment of the crotch belt length adjusting device according to the disclosure, in which the second end of the crotch belt forms a multi-layer folding structure.

FIG. 17 is a front partial schematic view of the child carrier adopting yet another embodiment of the crotch belt length adjusting device according to the disclosure, in which the wing part of the multi-layer folding structure has not passed through the second end obstruction member penetrating slot of the second end obstruction member.

FIG. 18 is a schematic view of the multi-layer folding structure and the second end obstruction member shown in FIG. 17.

FIG. 19 is a front partial schematic view of a child carrier adopting yet another embodiment of the crotch belt length adjusting device according to the disclosure, in which the wing part of the multi-layer folding structure has passed through the second end obstruction member penetrating slot of the second end obstruction member.

FIG. 20 is a schematic view of the multi-layer folding structure and the second end obstruction member shown in FIG. 19.

FIG. 21 is a front partial sectional view of the child carrier adopting an embodiment of the crotch belt length adjusting device according to the disclosure, in which a first end of the crotch belt is formed with a first end stop structure.

FIG. 22A is a schematic view of the child carrier adopting a second embodiment of the crotch belt length adjusting device and the waist belt distance adjusting device according to the disclosure, in which the crotch belt is connected to a safety belt.

FIG. 22B is another schematic view of the child carrier shown in FIG. 22A, in which the crotch belt is disconnected from the safety belt.

FIG. 23 is a schematic front view of the child carrier shown in FIG. 22A, in which the safety belt is removed.

FIG. 24 is a schematic back view and a partial enlarged view of the child carrier shown in FIG. 22A.

FIG. 25 is another schematic back view and partial enlarged view of the child carrier shown in FIG. 22A.

FIG. 26 is a side sectional view and a partial enlarged view of the child carrier shown in FIG. 22A.

FIG. 27 is a schematic view of the child carrier adopting another embodiment of the second embodiment of the crotch belt length adjusting device according to the disclosure, in which no connecting hole is arranged among a plurality of second holes.

FIG. 28 is a schematic back view of the child carrier shown in FIG. 27.

FIG. 29 is a schematic view of the child carrier adopting the waist belt distance adjusting device according to the disclosure, in which a half bowknot safety belt is formed at the second end of the safety belt.

### DETAILED DESCRIPTION

The crotch belt of a common child carrier is not adjustable in length, such that when the safety belt (i.e., shoulder belt) of the child carrier is adjusted, the buckle may be too low because the crotch belt is too short, which affects the comfort and safety of the child in sitting and using.

Therefore, the disclosure provides a crotch belt length adjusting device which can adjust the length of the crotch belt at different adjusting positions, so as to be suitable for children of different sizes, and it is convenient and quick to adjust the adjusting position of the crotch belt.

It should be noted, the child carrier in the disclosure can be various appliances for carrying children, including but not limited to a safety seat, a cart, a dining chair, a rocking chair and the like. For facilitating description, illustration will be carried out by taking the child carrier as a safety seat.

The present disclosure will be described in detail with reference to the accompanying drawings.

### First Embodiment of Crotch Belt Length Adjusting Device

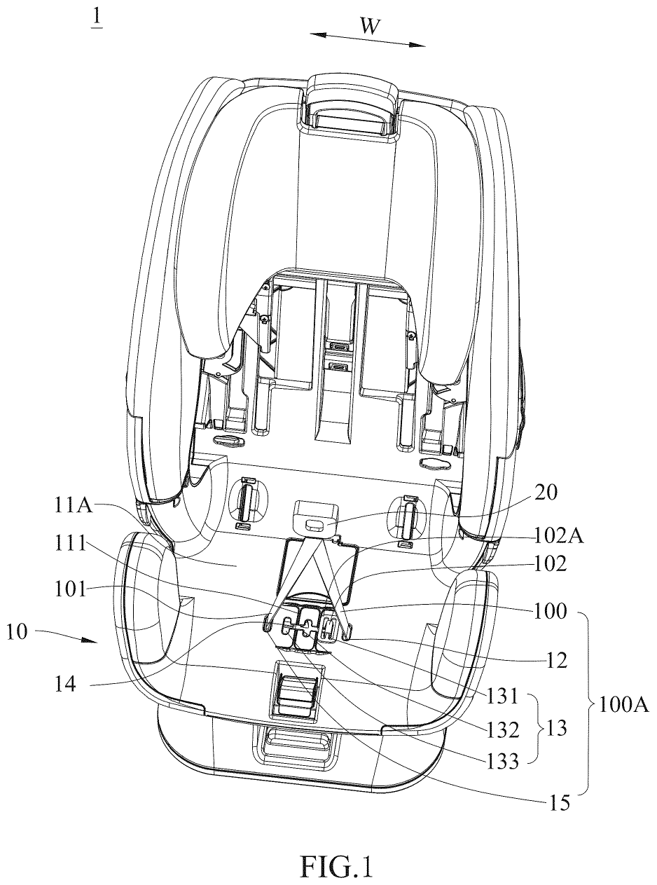

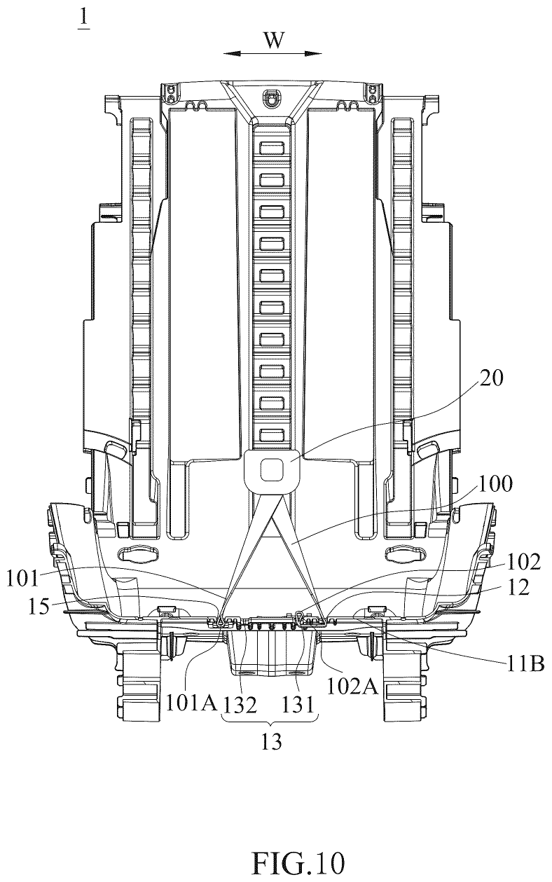

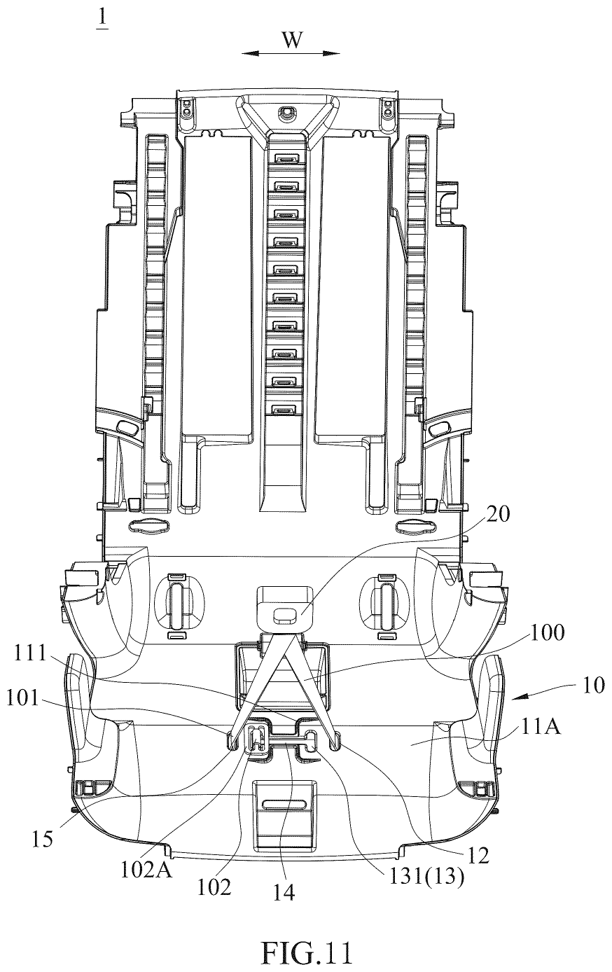

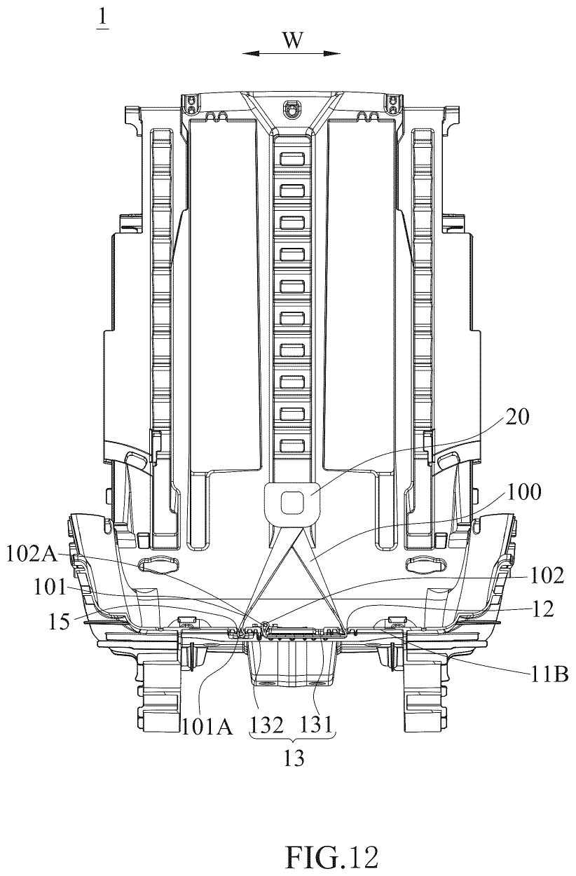

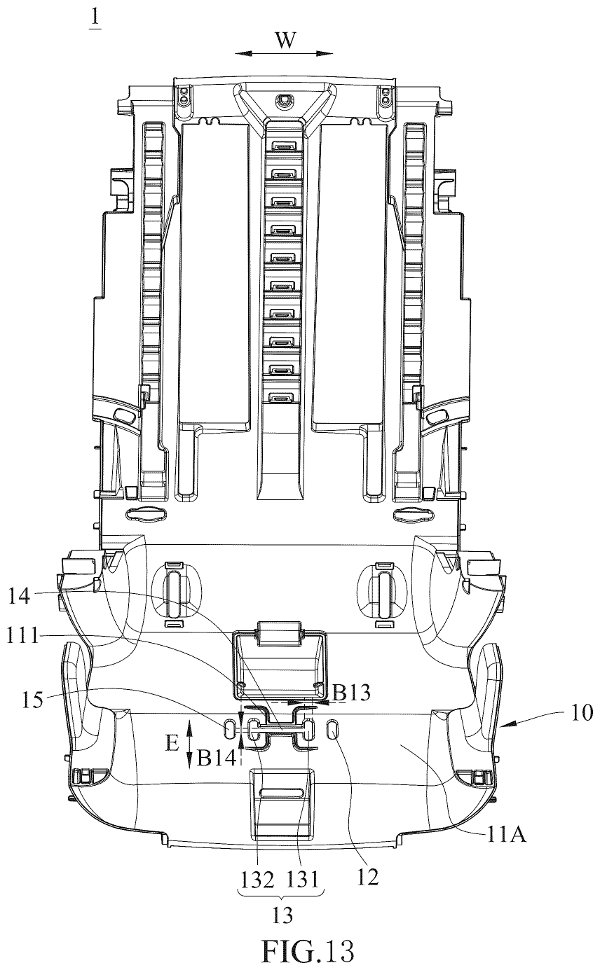

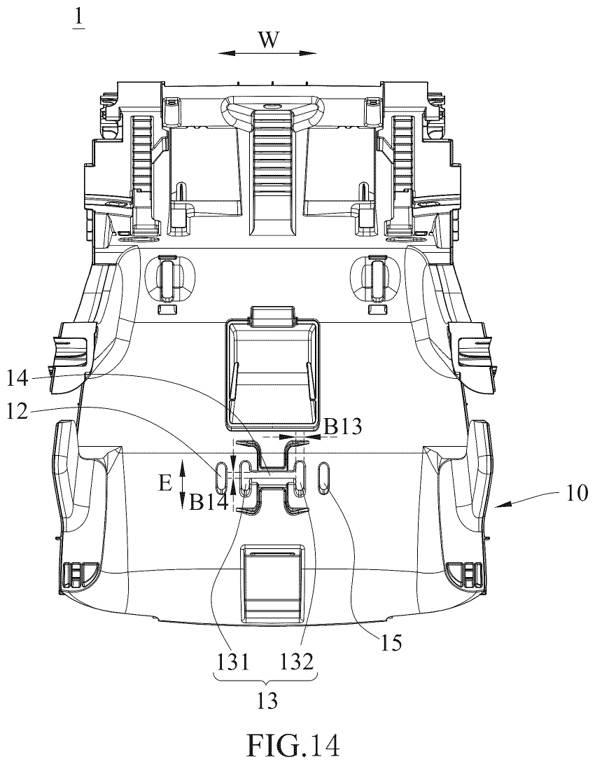

FIGS. 1 to 16 show a child carrier 1 having the crotch belt length adjusting device of a first embodiment according to the disclosure, in which the child carrier 1 includes a seat part 10, a backrest, and a headrest. It should be noted, the seat part 10 in the disclosure refers to a seat housing.

The crotch belt length adjusting device 100A according to the disclosure includes a crotch belt 100, and the crotch belt 100 has a first end 101 and a second end 102.

In order to adjust the crotch belt 100, the crotch belt length adjusting device 100A further includes a first hole 15, an adjustment hole 12, and a plurality of second holes 13, which are formed penetrating through the seat part 10 of the child carrier 1.

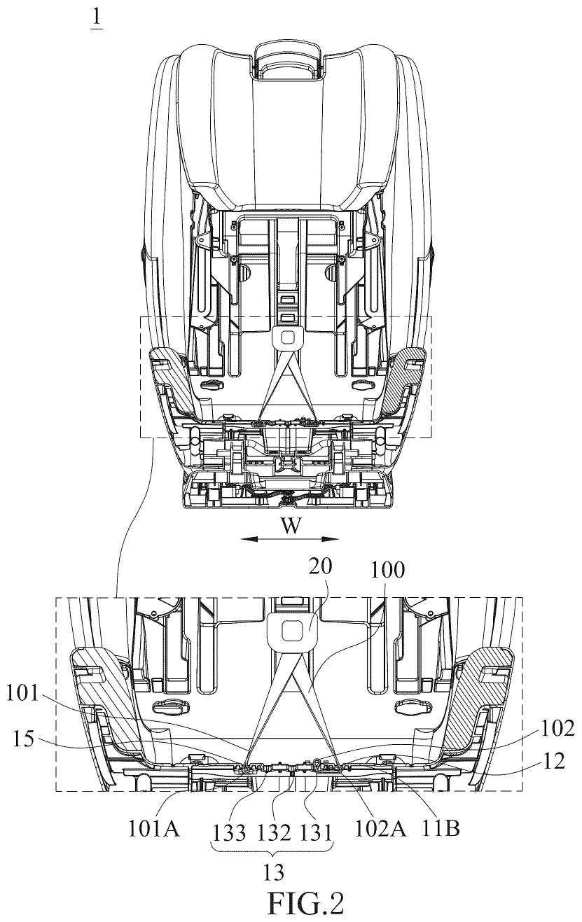

As shown in FIGS. 1-6 and 9-12, the first end 101 of the crotch belt 100 passes through a first hole 15 from an upper surface 11A of the seat part 10 and is exposed on a lower surface 11B of the seat part 10 (see FIGS. 2, 4, 6, 10, 12 and 16). A portion of the first end 101 exposed on the lower surface 11B is provided with a first end obstruction member 101A (see FIGS. 2, 4, 6, 10, 12), and the first end obstruction member 101A is arranged as unable to pass through the first hole 15. That is, the first end 101 of the crotch belt 100 may be exposed on the lower surface 11B of the seat part 10 after passing through the first hole 15, and the first end obstruction member 101A is then provided at the exposed portion of the first end 101.

Thus, when the first end 101 passes through the first hole 15 from the upper surface 11A of the seat part 10, it will not be obstructed by the first hole 15 due to the first end obstruction member 101A. However, after the first end 101 is exposed on the lower surface 11B of the seat part 10 by passing through the first hole 15, the first end obstruction member 101A is provided at the exposed portion of the first end 101, since the first end obstruction member 101A is obstructed at the lower surface 11B of the seat part 10 by the first hole 15, the first end 101 provided with the first end obstruction member 101A cannot pass through the first hole 15 from the lower surface 11B of the seat part 10 and retreat to the upper surface 11A, such that when a middle part of the crotch belt 100 travels upward, the first end 101 can only travel upward until the first end obstruction member 101A is obstructed, thereby ensuring that the first end 101 will not leave the seat part 10, thus realizing connection between the first end 101 and the seat part 10.

The size of the first end obstruction member 101A may be set to be larger than the first hole 15, such that the first end obstruction member 101A cannot pass through the first hole 15. In the embodiments shown in FIGS. 1-6, 9-14 and 16, the first end obstruction member 101A is a frame buckle with a middle cross bar with a size larger than that of the first hole 15.

In the embodiment, “frame buckle with a middle cross bar” includes a substantially rectangular ring with at least one middle cross bar and the like, and the disclosure is not limited thereto.

For example, in another embodiment, the first end obstruction member 101A may be a bowknot formed by folding a portion of the crotch belt 100 adjacent to the first end 101 in respect to itself multiple times, such that the bowknot is larger than the first hole 15 in size and cannot pass through the first hole 15.

In some embodiments, the first end obstruction member 101A located below the seat part 10 may drop down due to its own weight, and bring the first end 101 of the crotch belt 100 to drop down together, resulting in the portion of the crotch belt 100 below the seat part 10 being too long, which may affect the use of the crotch belt 100.

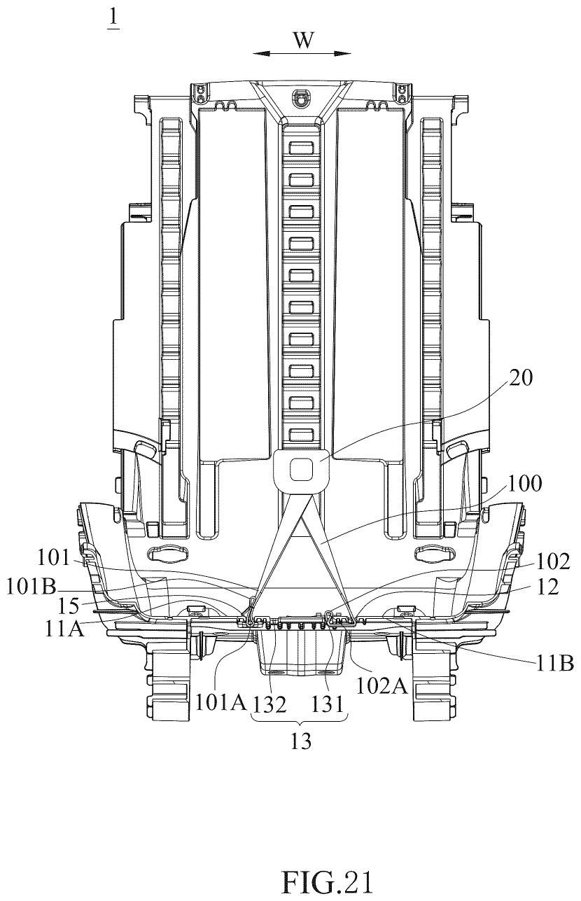

For this reason, in the embodiment shown in FIG. 21, the portion of the crotch belt 100 adjacent to the first end 101 is provided with a first end stop structure 101B, and the first end stop structure 101B is positioned above the upper surface 11A of the seat part 10 and is arranged unable to pass through the first hole 15. Thus, the first end stop structure 101B will limit the first end 101 of the crotch belt 100 from dropping down.

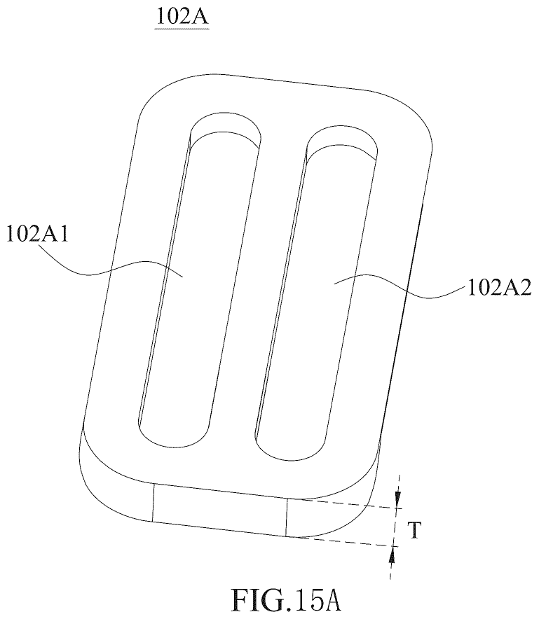

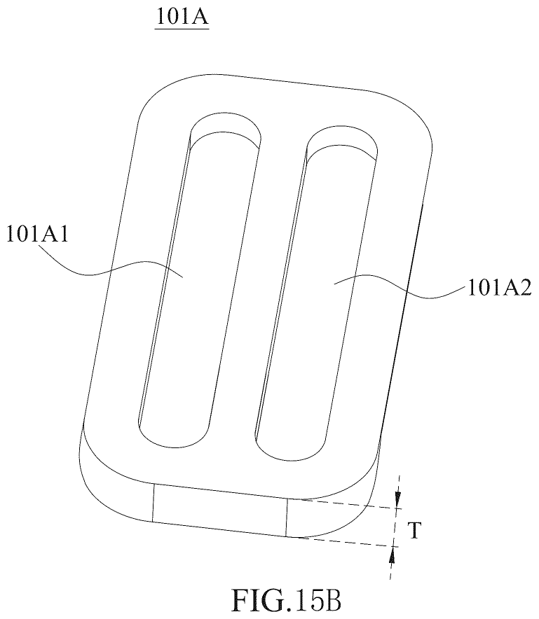

Specifically, In the case that the first end obstruction member 101A has at least one (two as shown in FIG. 15B) first end obstruction member penetrating slot 101A1, 101A2, as shown in FIG. 21, the first end stop structure 101B may be formed by the first end 101 of the crotch belt 100 passing through the first hole 15 and the first end obstruction member penetrating slot 101A1, 101A2 successively from the upper surface 11A of the seat part 10, and then reversely passing through the first hole 15 to reach above the upper surface 11A of the seat part 10, and being connected with other parts of the crotch belt 100 located above the upper surface 11A of the seat part 10.

In order to ensure that the first end stop structure 101B does not pass through the first hole 15, as shown in FIG. 21, the first end stop structure 101B may be formed as a half bowknot with a wing part larger than the first hole 15 in size, and a free end of the half bowknot may be arranged to abut against the upper surface 11A of the seat part 10.

Alternatively, in another embodiment, the first end stop structure 101B may be formed as a bowknot with two wing parts larger than the first hole 15 in size.

Alternatively, the first end 101 of the crotch belt 100 may be connected to the seat part 10 in other ways.

In another embodiment, the crotch belt length adjusting device 100A according to the disclosure may not be provided with the first hole 15, the upper surface 11A of the seat part 10 may be provided with a fixing structure such as a hanging hook, a hanging ring and the like, and the first end 101 of the crotch belt 100 is connected to the fixing structure, such that the first end 101 will not be separated from the seat part 10.

In yet another embodiment, the first end 101 of the crotch belt 100 may be arranged to be one-way removably fixed to the seat part 10. For example, the first end 101 may be arranged to be downward removably fixed to the seat part 10.

Further, as shown in FIGS. 1-6 and 9-12, the second end 102 of the crotch belt 100 passes through the adjustment hole 12 from the upper surface 11A of the seat part 10 to the lower surface 11B of the seat part 10 (see FIGS. 2, 4, 6, 10, 12 and 16), and then passes through one of the second holes 13 from the lower surface 11B to the upper surface 11A and is exposed on the upper surface 11A.

In the crotch belt length adjusting device 100A according to the disclosure, the crotch belt 100 is adjusted at the different adjusting positions, and the plurality of second holes 13 are used to realize conversion among a plurality of the adjusting positions. By moving the second end 102 between different the second holes 13, changes in the length of the use section of the crotch belt 100 can be realized.

The second end 102 of the crotch belt 100 is exposed on the upper surface 11A of the seat part 10, which may facilitate the user to move the second end 102 from one of the second holes 13 to another of the second holes 13, thereby realizing the adjustment for the adjusting positions (to be described later).

In addition, after the second end 102 of the crotch belt 100 passes through the adjustment hole 12 and one of the second holes 13 successively, the traveling direction of the second end 102 is different from that of the middle part of the crotch belt 100. For example, when the middle part of the crotch belt 100 travels upward, the second end 102 may travel downward.

As shown in FIGS. 1-6 and 9-12, a portion of the second end 102 exposed on the upper surface 11A is provided with a second end obstruction member 102A, and the second end obstruction member 102A is arranged as unable to pass through the second holes 13. That is, after the second end 102 of the crotch belt 100 is exposed on the upper surface 11A of the seat part 10 through one of the second holes 13, the exposed portion of the second end 102 is provided with the second end obstruction member 102A.

Thus, when the second end 102 passes through the adjustment hole 12 from the upper surface 11A of the seat part 10 and then passes through one of the second holes 13 from the lower surface 11B, the second end 102 will not be obstructed by the adjustment hole 12 and the second holes 13 due to the second end obstruction member 102A. However, after the second end 102 is exposed on the upper surface 11A of the seat part 10 through the second hole 13 and the exposed portion is provided with the second end obstruction member 102A, since the second end obstruction member 102A is obstructed by second holes 13 onto the upper surface 11A of the seat part 10, the second end 102 provided with the second end obstruction member 102A cannot pass through the second hole 13 from the upper surface 11A of the seat part 10 and retreat to the lower surface 11B, such that when the middle part of the crotch belt 100 travels upward, the second end 102 can only travel downward until the second end obstruction member 102A is obstructed, thereby ensuring that the second end 102 will not be separated from the seat part 10.

The size of the second end obstruction member 102A may be arranged to be larger than that of the second holes 13, such that the second end obstruction member 102A cannot pass through the second holes 13. In the embodiments shown in FIGS. 1-6 and 9-12, the second end obstruction member 102A is a frame buckle with a middle cross bar with a size larger than that of the second holes 13. Moreover, in order to make the frame buckle with a middle cross bar 102A more reliably abut against the upper surface 11A of the seat part 10, a limiting rib 111 is formed around each of the second holes 13 on the upper surface 11A (see FIGS. 1, 3, 5, 7, 9, 11, 13). The contour of each of the limiting ribs 111 is corresponding to the shape of the frame buckle with a middle cross bar 102A, so as to limit the position of the frame buckle with a middle cross bar 102A on the upper surface 11A. The limiting ribs 111 protrude from the upper surface 11A of the seat part 10.

Of course, the disclosure is not limited to this.

For example, in another embodiment, the second end obstruction member 102A may also be a bowknot formed by folding a portion of the crotch belt 100 adjacent to the second end 102 in respect to itself multiple times, such that the bowknot is larger than the second holes 13 in size and cannot pass through the second holes 13.

In addition, the second end 102 of the crotch belt 100 may be connected to the seat part 10 in other ways.

In another embodiment, the crotch belt 100 passes through the adjustment hole 12, and the second end 102 of the crotch belt 100 is arranged to be one-way removably fixed to one of the second holes 13. For example, the second end 102 is arranged to be upward removably fixed to one of the second holes 13.

After the second end 102 passes through the adjustment hole 12, since the crotch belt 100 can travel bidirectionally through the adjustment hole 12, the length of the used section of the crotch belt 100 between the first end 101 and the adjustment hole 12 can be increased or decreased as required.

It should be noted, the used section of the crotch belt 100 refers to a section of the crotch belt 100 located between the first end 101 and the adjustment hole 12. A buckle 20 is slidably connected to the used section of the crotch belt 100, and the buckle 20 is used for connecting to a safety belt 200 of the child carrier 1 (to be described later).

Since the crotch belt 100 is not fixedly connected to the adjustment hole 12, the crotch belt 100 can travel bidirectionally through the adjustment hole 200, so the length of the used section of the crotch belt 100 will change. The user can increase the length of the used section of the crotch belt 100 by moving any part of the used section of the crotch belt 100 upward, until the second end 102 of the crotch belt 100 moving downward is obstructed by the second end obstruction member 102A. In addition, the user makes the second end 102 of the crotch belt 100 pass through second holes 13, since the distances between different second holes 13 and the adjustment hole 12 are varied, the length of a section of the crotch belt 100 between the second end 102 and the adjustment hole 12 is changed, such that the length of the used section of the crotch belt 100 is changed accordingly, so the length of the used section of the crotch belt 100 can be adjusted, and further, a height of the buckle 20 on the used section of the crotch belt 100 in respect to the seat part 10 can be adjusted, so the crotch belt 100 can be suitable for children with different body sizes.

In order to prevent the crotch belt 100 from causing discomfort to the child sitting in the child carrier 1, the crotch belt 100 usually adopts a flat broad belt. Correspondingly, as shown in FIGS. 1-6 and 9-12, each of the first hole 15, the plurality of second holes 13, and the adjustment hole 12 can be formed into an elongated hole, such that the crotch belt 100 can pass through these holes more smoothly. Moreover, the elongated holes can prevent the crotch belt 100 from twisting, thereby preventing a twisted crotch belt 100 causing discomfort to the child sitting in the child carrier 1.

The first hole 15, the plurality of second holes 13, and the adjustment hole 12 may be the same in shape and size, which may facilitate processing.

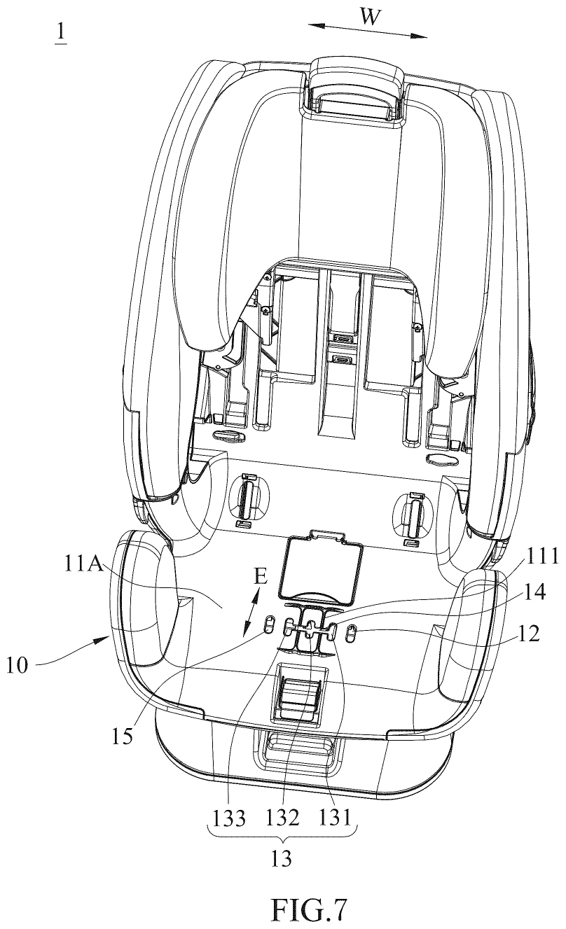

In an embodiment, as shown in FIGS. 7, 8, 13 and 14, extending directions E of the first hole 15, the plurality of second holes 13, and the adjustment hole 12 are parallel to each other and perpendicular to the width direction W of the seat part 10.

Furthermore, the first hole 15, the plurality of second holes 13, and the adjustment hole 12 are sequentially arranged side by side and at intervals along the width direction W of the seat part 10. In such configuration, the plurality of second holes 13 are located between the first hole 15 and the adjustment hole 12. When the second end 102 of the crotch belt 100 moves from one of the second holes 13 to another second hole 13, the spacing distance between the two second holes 13 is equal to a length change value of the used section of the crotch belt 100 at two different adjusting positions, i.e., an adjustment stroke between two adjusting positions of the crotch belt 100.

In yet another embodiment, the spacing distance between two adjacent second holes 13 may be 40 mm.

In order to facilitate the user to move the second end 102 of the crotch belt 100 from one of the second holes 13 to another second hole 13, in the embodiments shown in FIGS. 1 to 14, the plurality of second holes 13 can be communicated with each other through a connecting hole 14 formed penetrating through the seat part 10. Thus, the user only needs to move the second end 102 by operating the frame buckle with a middle cross bar 102A, such that the second end 102 can move among the plurality of second holes 13 via the connecting hole 14, thereby conveniently and quickly realizing the adjustment for the adjusting positions.

As shown in FIGS. 7, 8, 13 and 14, the connecting hole 14 can also be arranged as an elongated hole, and extend in a direction intersecting with the extending direction E of the second holes 13. In an embodiment, the connecting hole 14 is arranged to extend in a direction perpendicular to the extending direction E of the second holes 13. Such configuration can prevent the crotch belt 100 from accidentally sliding from one of the second holes 13 to another second hole 13 via the connecting hole 14.

Of course, the disclosure is not limited to this. Specifically, the first hole 15, the plurality of second holes 13, and the adjustment hole 12 may be formed into holes of other shapes. Moreover, their respective extending directions may not be parallel to each other, or may not be perpendicular to the width direction W of the seat part 10. In addition, the first hole 15, the plurality of second holes 13, and the adjustment hole 12 may be formed in the seat part 10 in other arrangements. Furthermore, the spacing distance between two adjacent second holes 13 may be 30 mm, or 50 mm, or set to other values as required.

The connecting hole 14 may not be arranged among the plurality of second holes 13, rather, alternatively, the second end 102 and the second end obstruction member 102A may be separated, so as to allow the second end 102 to retreat from the upper surface 11A of the seat part 10 through the second holes 13 and retreat to the lower surface 11B, and to be exposed on the upper surface 11A from the lower surface 11B through another second hole 13, thereby realizing that the second end 102 is moved from one of the second holes 13 to another second hole 13, and the second end 102 and the second end obstruction member 102A are connected together after the second end 102 is moved to another second hole 13.

Hereinafter, referring to FIGS. 1 to 8, cases of the crotch belt length adjusting device 100A according to the disclosure at respective adjusting positions will be described by taking the plurality of second holes 13 as three second holes 13 as an example. For facilitating description, the three second holes 13 are respectively a second hole 131 at first adjusting position, a second hole 132 at second adjusting position, and a second hole 133 at third adjusting position, such that the crotch belt length adjusting device 100A can perform the adjustment for three adjusting positions.

As shown in FIGS. 1 and 2, the second end 102 of the crotch belt 100 is exposed through the second hole 131 at first adjusting position, and abuts against the upper surface 11A of the seat part 10 by the second end obstruction member 102A at the second hole 131 at first adjusting position. Since the distance between the second hole 131 at first adjusting position and the adjustment hole 12 is the shortest, when the crotch belt 100 is tightened, the length of the section of the crotch belt 100 between the second end 102 and the adjustment hole 12 is the shortest, and accordingly, the used section of the crotch belt 100 between the first end 101 and the adjustment hole 12 is the longest, which can be suitable for children with larger body sizes.

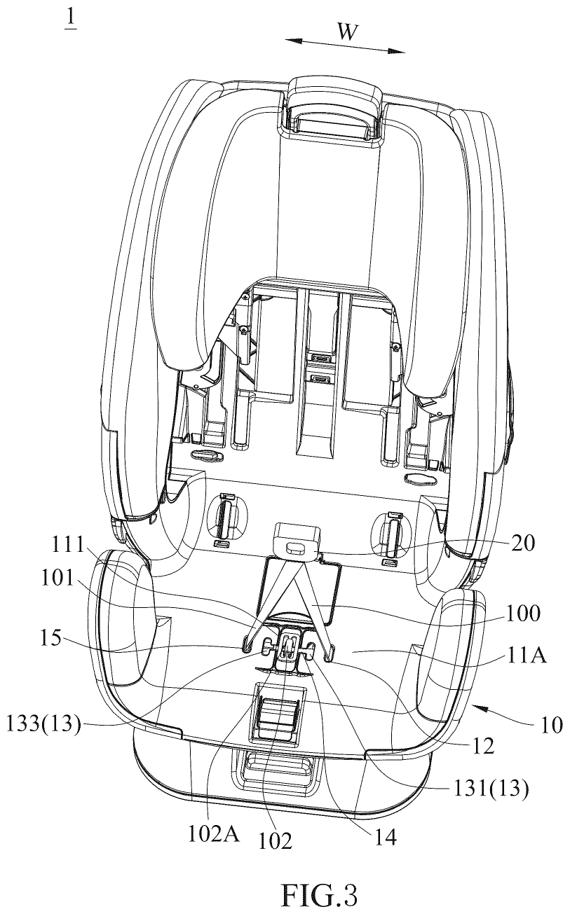

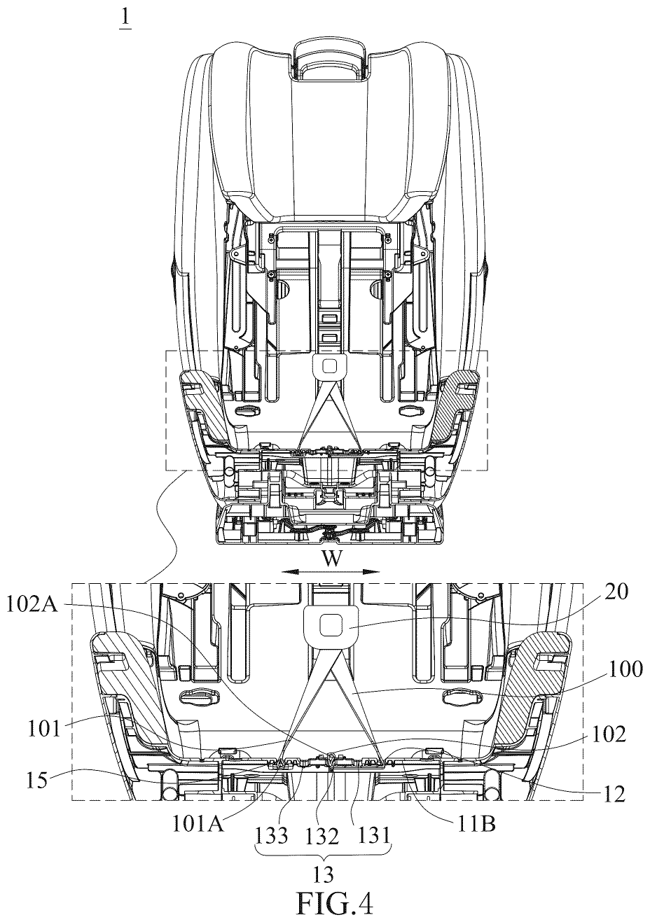

As shown in FIGS. 3 and 4, the second end 102 of the crotch belt 100 is exposed through the second hole 132 at second adjusting position, and abuts against the upper surface 11A of the seat part 10 by the second end obstruction member 102A at the second hole 132 at second adjusting position. Since the distance between the second hole 132 at second adjusting position and the adjustment hole 12 is relatively long, when the crotch belt 100 is tightened, the length of the section of the crotch belt 100 between the second end 102 and the adjustment hole 12 is relatively long, and accordingly, the used section of the crotch belt 100 between the first end 101 and the adjustment hole 12 is relatively short, which can be suitable for children with moderate body sizes.

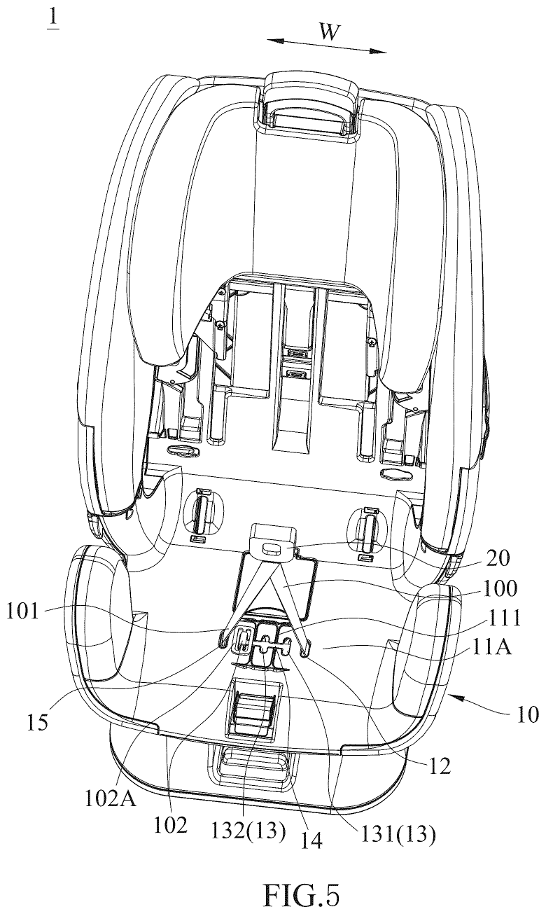

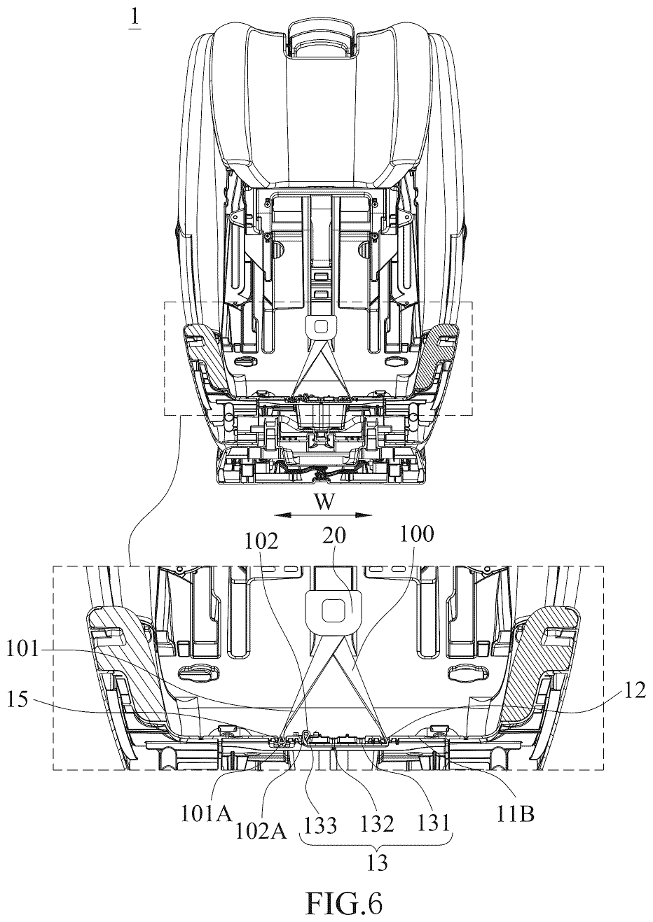

As shown in FIGS. 5 and 6, the second end 102 of the crotch belt 100 is exposed through the second hole 133 at third adjusting position, and abuts against the upper surface 11A of the seat part 10 by the second end obstruction member 102A at the second hole 133 at third adjusting position. Since the distance between the second hole 133 at third adjusting position and the adjustment hole 12 is the farthest, when the crotch belt 100 is tightened, the length of the section of the crotch belt 100 between the second end 102 and the adjustment hole 12 is the longest, and accordingly, the used section of the crotch belt 100 between the first end 101 and the adjustment hole 12 is the shortest, which can be suitable for children with smaller body sizes.

It should be understood, the plurality of second holes 13 may include two or more than three second holes, so as to meet different practical requirements.

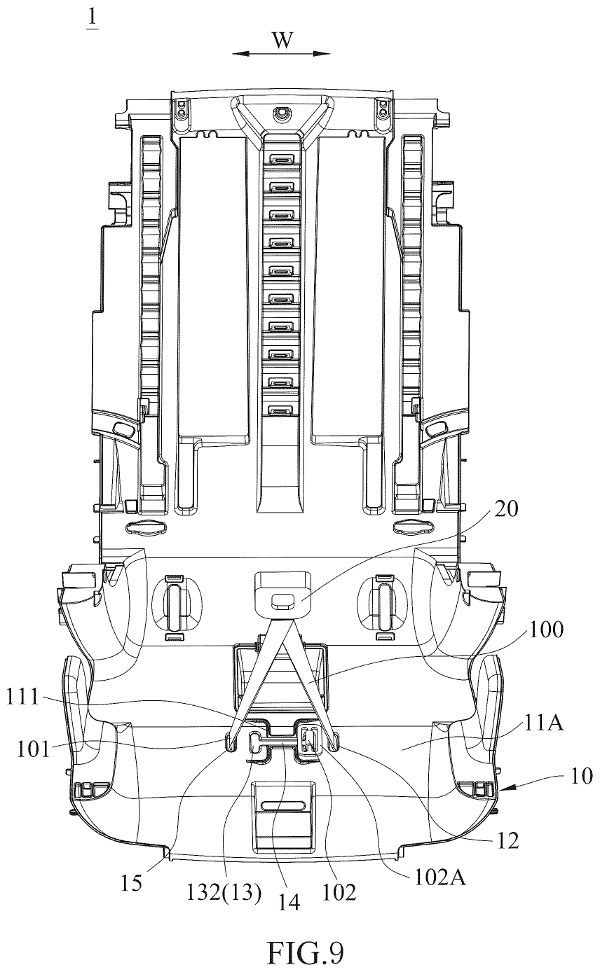

For example, FIGS. 9 to 14 show an embodiment in which the plurality of second holes 13 are implemented as two second holes 13 (i.e., the second hole 131 at first adjusting position and the second holes 132 at second adjusting position).

Compared with the above embodiment of three second holes 13, since the second holes 13 in this embodiment are reduced to two, the crotch belt length adjusting device 100A can perform the adjustment for two adjusting positions.

Moreover, in the case there are two second holes 13, the connecting hole 14 between the two second holes 13 can be arranged to be longer, so it can be more effective to prevent the crotch belt 100 from accidentally sliding from one of the second holes 13 to the other second hole 13 via the connecting hole 14.

In order to make the child carrier 1 more beautiful and comfortable, the seat part 10 may be provided with a removable cushion, and the cushion covers the upper surface 11A of the seat part 10. When it is required to perform the adjustment for adjusting positions of the crotch belt length adjusting device 100A, the user can remove the cushion, thereby operating the frame buckle with a middle cross bar 102A to move the second end 102 among the plurality of second holes 13 via the connecting hole 14.

In the process of using the crotch belt length adjusting device 100A, since the thickness T of the second end obstruction member 102A may be smaller than the width B13 of the second hole 13 or the width B14 of the connecting hole 14, the second end obstruction member 102A and the second end 102 of the crotch belt 100 connected thereto may accidentally pass through the second holes 13 or the connecting hole 14, resulting in the second end obstruction member 102A and the second end 102 of the crotch belt 100 connected thereto falling below the lower surface 11B of the seat part 10, such that the user cannot adjust the crotch belt 100.

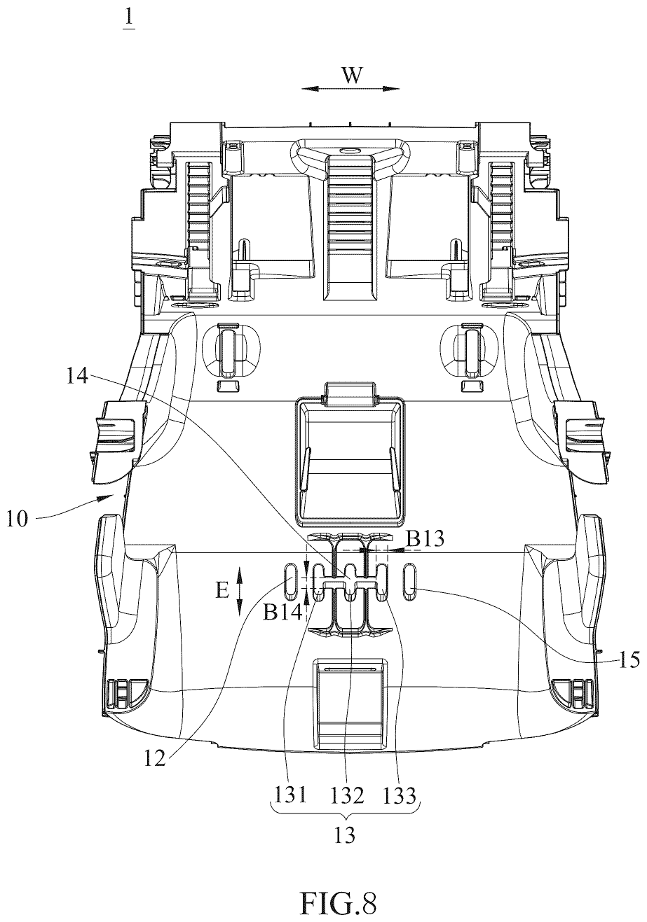

In order to avoid such accidental falling, in an embodiment, the thickness T of the second end obstruction member 102A (see FIG. 15A) is arranged to be greater than the width B13 of the second hole 13 (see FIGS. 8, 13 and 14) and greater than the width B14 of the connecting hole 14 (see FIGS. 8, 13 and 14).

In the specification, the width B13 of the second hole 13 and the width B14 of the connecting hole 14 respectively refer to the smallest of the sizes of the openings of the second hole 13 and the connecting hole 14, for example, the widths shown in FIGS. 8, 13 and 14.

The thickness T of the second end obstruction member 102A refers to the smallest size in the overall external sizes of the second end obstruction member 102A, for example, the thickness T of the frame buckle with a middle cross bar 102A shown in FIG. 15A.

Since the thickness T of the second end obstruction member 102A is the smallest size in its overall external sizes, when the smallest size (i.e., the thickness T) of the second end obstruction member 102A is greater than the width B13 of the second hole 13 and the width B14 of the connecting hole 14, the second end obstruction member 102A will not be able to pass through the second hole 13 or the connecting hole 14, such that the above-mentioned accidental falling can be avoided.

It should be understood, in the embodiment shown in FIG. 15A, the thickness T of the second end obstruction member 102A may refer to its own thickness. In another embodiment, the thickness T of the second end obstruction member 102A may refer to the thickness of the whole structure formed by additionally arranging, including welding, screwing, riveting, gluing and the like, a thickening part (not shown) such as a boss or a pin on the second end obstruction member 102A.

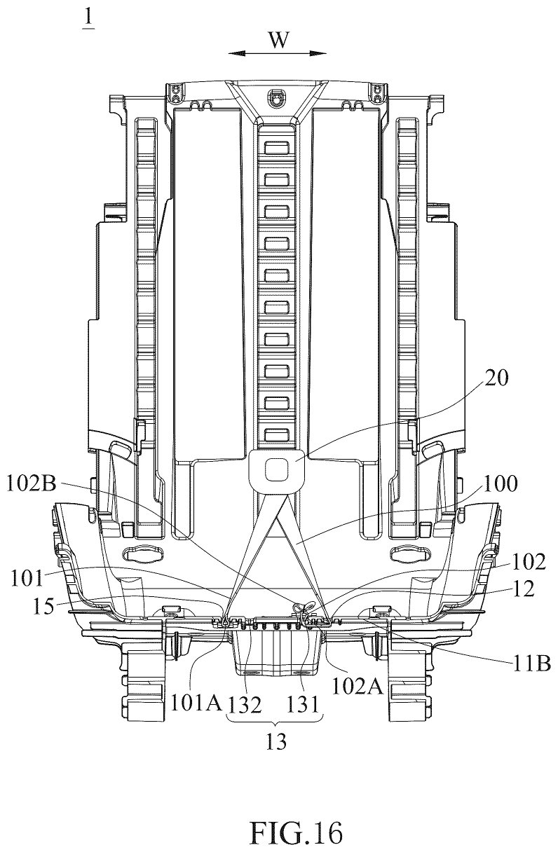

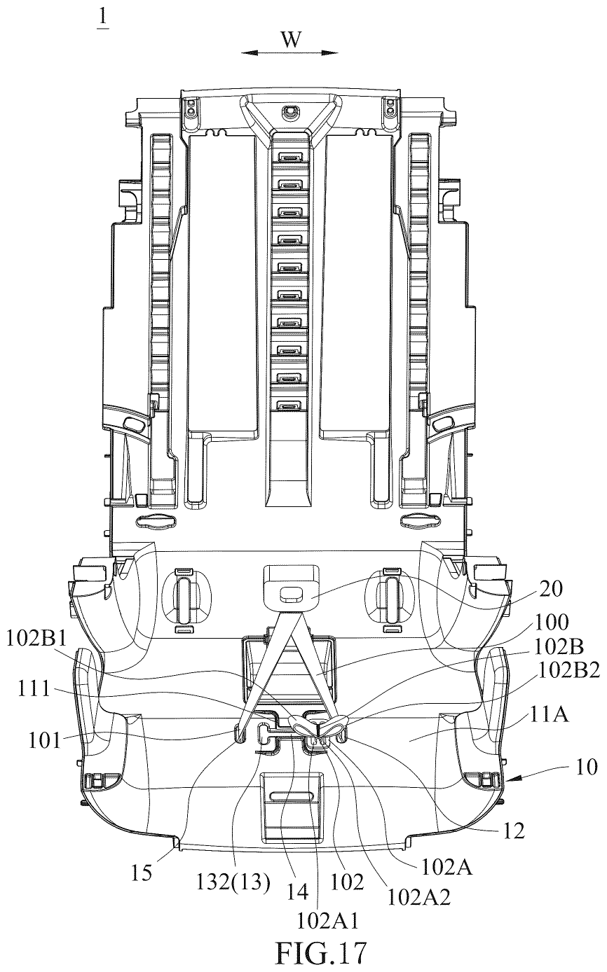

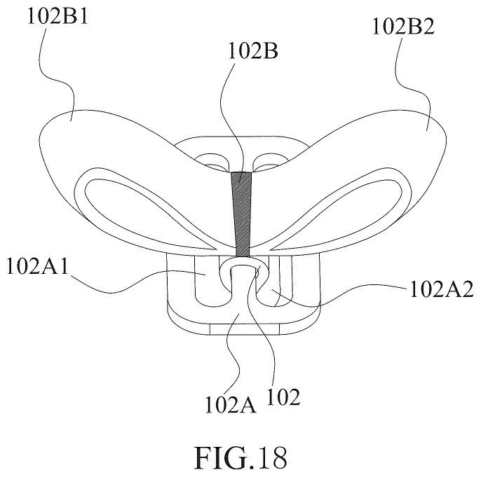

In yet another embodiment, as shown in FIGS. 16 to 20, a portion of the second end 102 of the crotch belt 100 exposed on the upper surface 11A may form a multi-layer folding structure 102B. That is, the portion of the second end 102 of the crotch belt 100 exposed on the upper surface 11A can be folded several times in respect to itself, and kept in a folded state by sewing, gluing and the like.

The second end obstruction member 102A may be disposed on the multi-layer folding structure 102B, such that a sum of thicknesses of the second end obstruction member 102A and the multi-layer folding structure 102B is greater than the width B13 of the second hole 13 and the width B14 of the connecting hole 14. Therefore, the second end obstruction member 102A, being connected to the multi-layer folding structure 102B, will not be able to pass through the second hole 13 or the connecting hole 14, such that the above-mentioned accidental falling can also be avoided.

In an embodiment, the second end obstruction member 102A may be disposed between the upper surface 11A and the multi-layer folding structure 102B, and the multi-layer folding structure 102B may be arranged to have a thickness greater than the width B13 of the second hole 13 and greater than the width B14 of the connecting hole 14. Therefore, the multi-layer folding structure 102B will not be able to pass through the second hole 13 or the connecting hole 14, such that the above-mentioned accidental falling can also be avoided.

In the embodiment shown in FIGS. 16 to 20, the multi-layer folding structure 102B may be a bowknot, thereby making it more beautiful.

As shown in FIGS. 16 to 20, the bowknot may have two wing parts 102B1, 102B2, and a spread bowknot will greatly increase the size of the multi-layer folding structure 102B through the two two wing parts 102B1, 102B2, such that the multi-layer folding structure 102B is larger than the width B13 of the second hole 13 and the width B14 of the connecting hole 14 not only in thickness but also in length. On the other hand, the spread bowknot makes the multi-layer folding structure 102B longer than the width B13 of the second hole 13 and the width B14 of the connecting hole 14 in length, even though it is relative thin in thickness. Thus, the multi-layer folding structure 102B may be prevented from accidentally passing through the second hole 13 or the connecting hole 14.

Of course, the disclosure is not limited to this.

The wing parts can be made separately alone, and then connected to the multi-layer folding structure 102B.

The material of the wing parts 102B1, 102B2 may be as same as that of the multi-layer folding structure 102B, for example, one part of the crotch belt 100 may be used to form the multi-layer folding structure 102B, and the other part may be used to form an annular structure extending from the multi-layer folding structure 102B, and the annular structure constitutes the wing parts 102B1, 102B2.

Alternatively, the material of the wing parts 102B1, 102B2 may be different from that of the multi-layer folding structure 102B, for example, the wing parts 102B1, 102B2 made of some another material may be connected to the multi-layer folding structure 102B by sewing, gluing and the like.

In an embodiment, the thickness T of the second end obstruction member 102A, the thickness of the multi-layer folding structure 102B, or the sum of the thickness T of the second end obstruction member 102A and the thickness of the multi-layer folding structure 102B may be greater than the width B13 of the second hole 13, thereby avoiding the situation that the second end obstruction member 102A and the second end 102 of the crotch belt 100 connected thereto may accidentally pass through the second hole 13, resulting in accidental falling below the lower surface 11B of the seat part 10.

In an embodiment, the thickness T of the second end obstruction member 102A, the thickness of the multi-layer folding structure 102B, or the sum of the thicknesses of the second end obstruction member 102A and the thickness of the multi-layer folding structure 102B may be greater than the width B14 of the connecting hole 14, thereby avoiding the situation that the second end obstruction member 102A and the second end 102 of the crotch belt 100 connected thereto may accidentally pass through the connecting hole 14, resulting in accidental falling below the lower surface 11B of the seat part 10.

In addition, in the case that the second end obstruction member 102A, such as the frame buckle with a middle cross bar and the like, and the multi-layer folding structure 102B are not fixed together, when the user adjusts the crotch belt 100, the second end obstruction member 102A may accidentally pass through the second hole 13 or the connecting hole 14 and fall below the seat part 10 because its thickness T is smaller than the width B13 of the second hole 13 or the width B14 of the connecting hole 14.

In order to prevent the second end obstruction member 102A from falling below the seat part 10, the disclosure provides a scheme to keep the multi-layer folding structure 102B and the second end obstruction member 102A together.

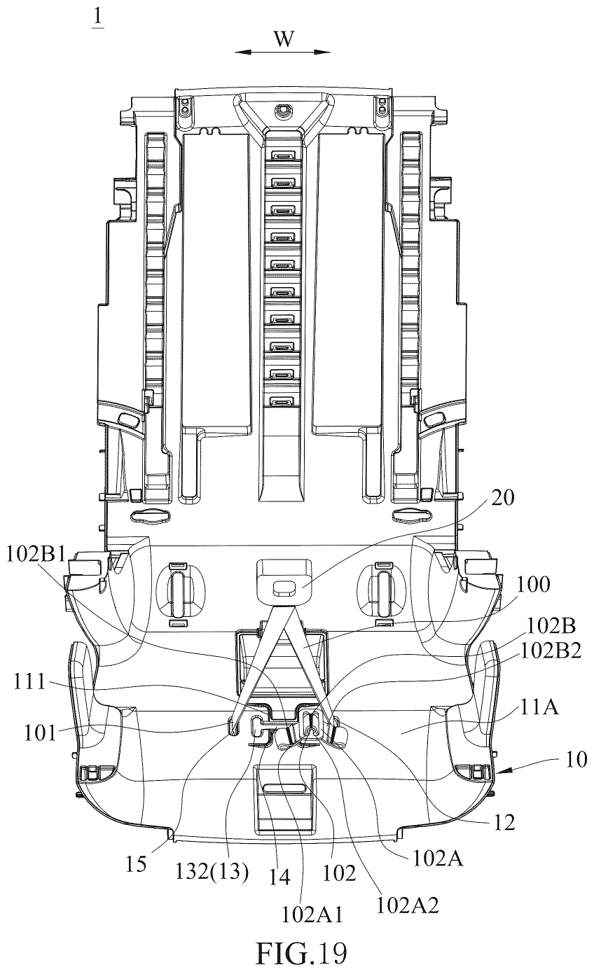

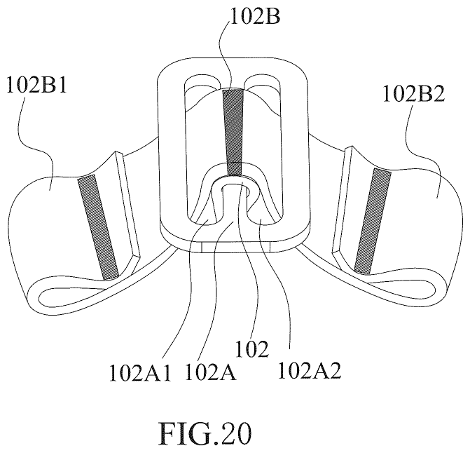

Specifically, the second end obstruction member 102A A may have at least one (two as shown in FIG. 15A) second end obstruction member penetrating slot 102A1, 102A2, and the multi-layer folding structure 102B may be provided with at least one (two as shown in FIGS. 16 to 20) wing part 102B1, 102B2, and the wing part 102B1, 102B2 may be arranged to pass through the second end obstruction member penetrating slot 102A1, 102A2, as shown in FIGS. 19 and 20, such that the multi-layer folding structure 102B and the second end obstruction member 102A are held together, and the second end obstruction member 102A cannot pass through the second hole 13 or the connecting hole 14 alone and fall below the seat part 10.

It should be understood, in the case that the multi-layer folding structure 102B includes a plurality of wing parts, the plurality of wing parts may respectively pass through different second end obstruction member penetrating slots, or the plurality of wing parts may all pass through the same second end obstruction member penetrating slot.

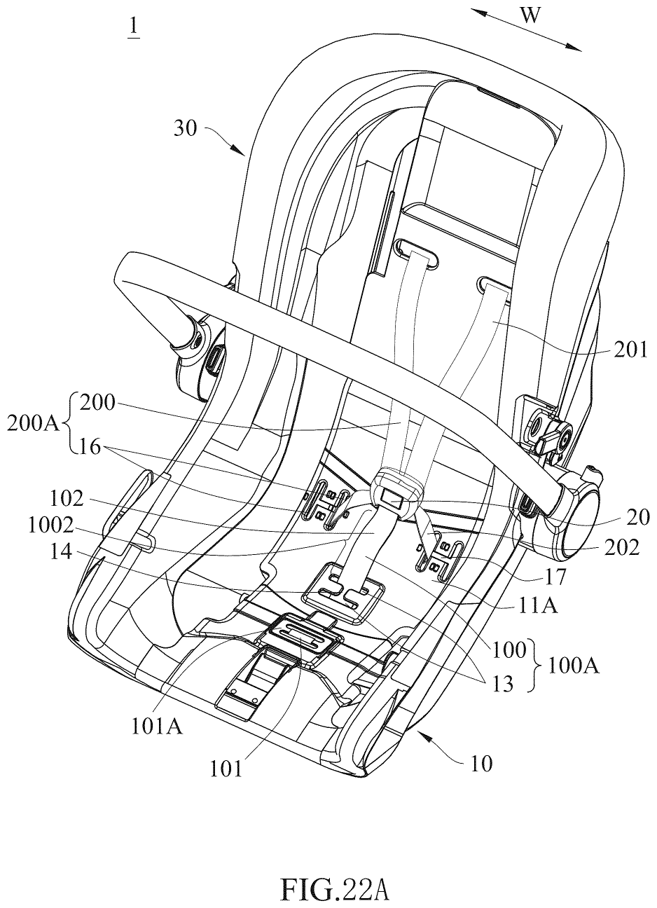

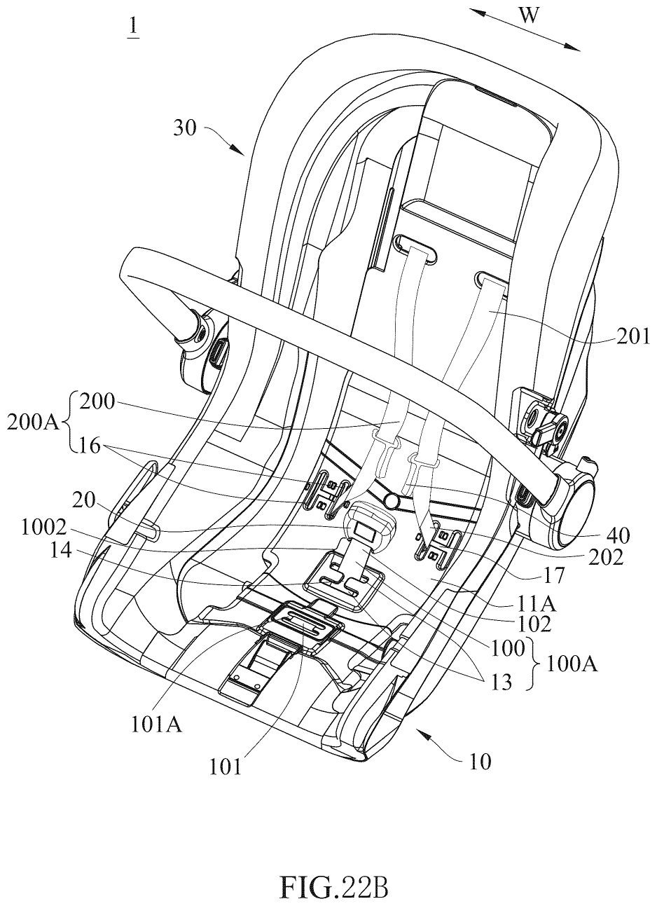

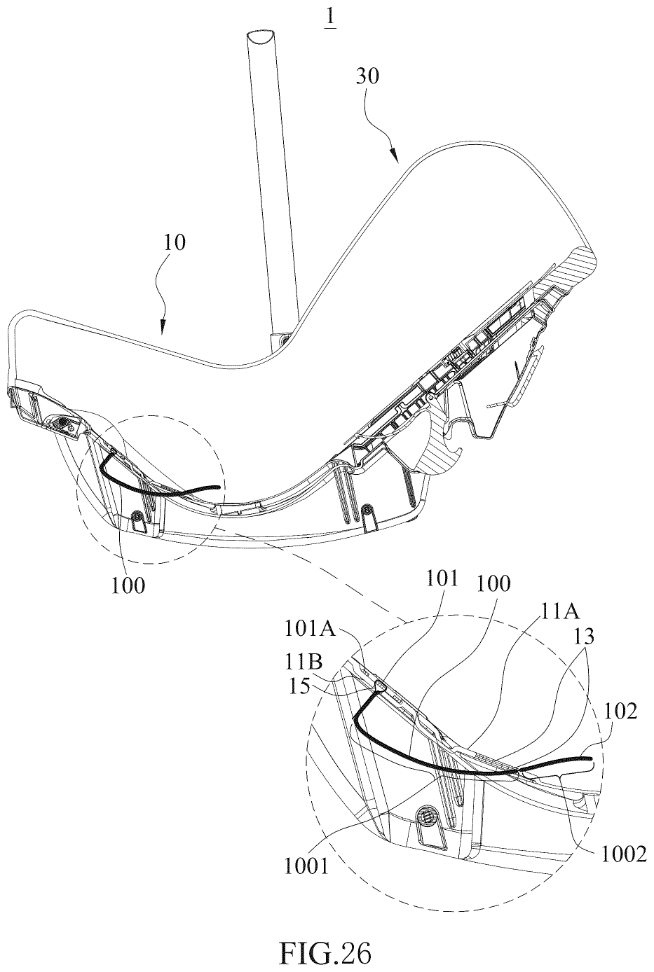

SECOND EMBODIMENT OF CROTCH BELT LENGTH ADJUSTING DEVICE FIGS. 22A to 28 show a child carrier 1 adopting a second embodiment of the crotch belt length adjusting device 100A according to the disclosure.

The second embodiment of the crotch belt length adjusting device 100A according to the disclosure also includes a crotch belt 100, and the crotch belt 100 has a first end 101 and a second end 102.

The first end 101 of the crotch belt 100 can be connected to the seat part 10 of the child carrier 1 in various ways. For example, the lower surface 11B of the seat part 10 may be provided with a fixing structure such as a hanging hook, a hanging ring, or a hole and the like, and the first end 101 of the crotch belt 100 can be connected to the fixing structure, such that the first end 101 will not be separated from the seat part 10.

FIGS. 22A to 28 show an embodiment in which the first end 101 of the crotch belt 100 is connected to the seat part 10 of the child carrier 1. In this embodiment, the first end 101 of the crotch belt 100 is arranged to be one-way removably fixed to seat part 10. For example, the first end 101 may be arranged to be upward removably fixed to the seat part 10.

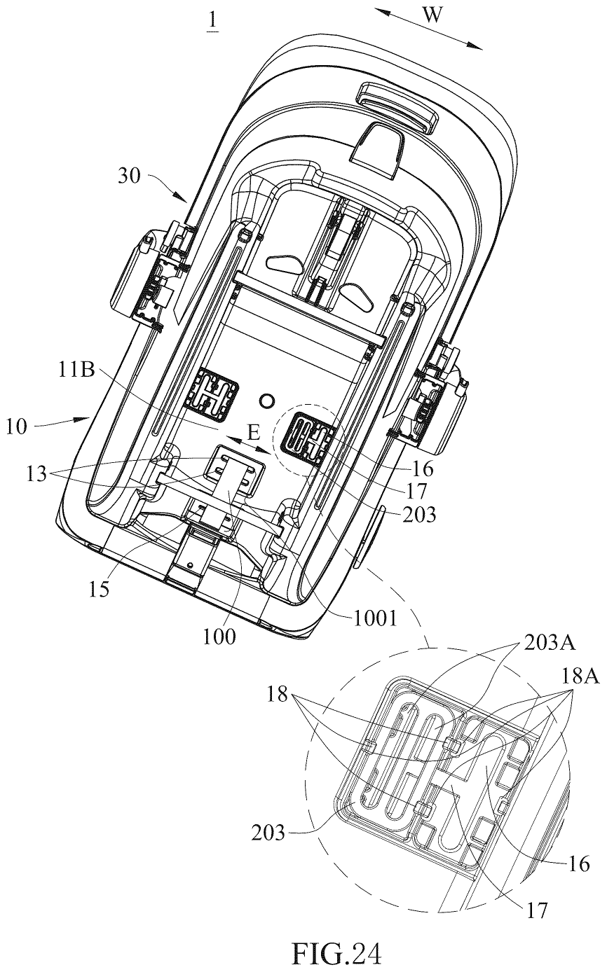

Among them, the crotch belt length adjusting device 100A further includes a first hole 15 formed penetrating through the seat part 10 (see FIGS. 24 to 26 and 28). The first end 101 of the crotch belt 100 is exposed from the lower surface 11B of the seat part to the upper surface 11A of the seat part through the first hole 15. Furthermore, the portion of the first end 101 exposed on the upper surface 11A is provided with a first end obstruction member 101A (see FIGS. 22A, 22B, 23, 26), so as to prevent the first end 101 from passing through the first hole 15 from the upper surface 11A of the seat part 10 and retreating below the lower surface 11B, thereby preventing the first end 101 from separating from the seat part 10 and realizing the connection between the first end 101 and the seat part 10. In addition, the first end 101 of the crotch belt 100 may be, after passing through the first hole 15, exposed on the upper surface 11A of the seat part 10, and then is provided with a first end obstruction member 101A on the exposed portion thereof.

It should be understood, the first end obstruction member 101A in the second embodiment may be as same as or different from the first end obstruction member 101A in the first embodiment. For example, the first end obstruction member 101A can also adopt a frame buckle with a middle cross bar or a multi-layer folding structure larger than the first hole 15 in size.

In an embodiment, the first end obstruction member 101A may be arranged to have a length and a width both larger than the width of the first hole 15, such that the first end obstruction member 101A cannot pass through the first hole 15 along a normal direction of the plane formed by an edge in the length direction and an edge in the width direction of the first end obstruction member, such that the first end obstruction member 101A is obstructed by the first hole 15 on the upper surface 11A of the seat part 10, and thus causing that the first end 101 provided with the first end obstruction member 101A cannot pass the first hole 15.

In this embodiment, the first end obstruction member 101A may be arranged such that the sum of its thickness and the thickness of the crotch belt 100 is greater than, equal to or smaller than the width of the first hole 15. In the case that the sum of thicknesses of the first end obstruction member 101A and the crotch belt 100 is greater than the width of the first hole 15, since all the overall dimensions (lengths, widths and thicknesses) of the first end obstruction member 101A and the crotch belt 100 are greater than the width of the first hole 15, the first end obstruction member 101A arranged together with the crotch belt 100 cannot pass through the first hole 15 at any angle, so the first end 101 of the crotch belt 100 must be separated from the first end obstruction member 101A, then it can pass through the first hole 15. In the case that the sum of thicknesses of the first end obstruction member 101A and the crotch belt 100 is equal to, and preferably smaller than, the width of the first hole 15, the first end obstruction member 101A arranged together with the crotch belt 100 can pass through the first hole 15 along a direction in which their thickness end faces are aligned with the first hole 15, such that the crotch belt 100 provided with the first end obstruction member 101A can be selectively obstructed by the first hole 15 or passed through the first hole 15 without being separated from the first end obstruction member 101A, which is helpful for connecting and disconnecting the first end 101 of the crotch belt 100 with the seat part 10.

In order to perform an adjustment to the crotch belt 100, the second embodiment of the crotch belt length adjusting device 100A also includes a plurality of second holes 13 formed penetrating through the seat part 10.

As shown in FIGS. 22A to 28, the second end 102 of the crotch belt 100 is exposed on the upper surface 11A of the seat part 10 from the lower surface 11B of the seat part 10 through one of the second holes 13, so as to be connected to the safety belt 200 on the child carrier 1.

In the disclosure, the second end 102 of the crotch belt 100 can be connected to the safety belt 200 on the child carrier 1 in various common ways. For example, in the embodiment shown in FIGS. 22A and 22B, the second end 102 of the crotch belt 100 is provided with a buckle 20, and a connecting clasp 40 is disposed between a first end 201 and a second end 202 of the safety belt 200 (see FIG. 22B), such that the second end 102 of the crotch belt 100 can be connected to the safety belt 200 by engagement of the connecting clasp 40 and the buckle 20. Of course, the buckle 20 is not necessarily arranged at the second end 102, and it may be arranged at other positions of the portion of the crotch belt 100 exposed above the upper surface 11A of the seat part 10.

In the second embodiment of the crotch belt length adjusting device 100A according to the disclosure, adjustment of the crotch belt 100 is also performed at respective adjusting positions, and the plurality of second holes 13 are used to realize conversion between the plurality of adjusting positions. By moving the crotch belt 100 among different second holes 13, different changes in the length of the used section of the crotch belt 100 can be implemented.

In both the first and second embodiments of the crotch belt length adjusting device 100A, the length of the used section of the crotch belt 100 is adjusted by changing the length of a hidden section 1001 (to be described later) of the crotch belt 100 hidden below the seat part 10. It should be noted, however, the second embodiment of the crotch belt length adjusting device 100A has the following differences from the first embodiment:
1. In the second embodiment of the crotch belt length adjusting device 100A, the position of the crotch belt 100 protruding along a front-back direction perpendicular to the width direction of the seat part 10 is changed, so as to satisfy children with different body sizes; moreover, by exposing the second end 102 of the crotch belt 100 to the upper surface 11A of the seat part 10 from different second holes 13, the length of the used section of the crotch belt 100 and the position of the crotch belt 100 in the front-back direction of the seat part 10 can be adjusted.
2. Due to differences in structure, in the second embodiment, the used section of the crotch belt 100 refers to a section of the crotch belt 100 between the second end 102 and second holes 13 and the second hole 13, i.e., the portion of the crotch belt 100 exposed on the upper surface 11A of the seat part 10.

In the second embodiment of the crotch belt length adjusting device 100A, the crotch belt 100 can also be moved from one of the second holes 13 to another second hole 13, thereby realizing the adjustment for adjusting positions.

Specifically, since the crotch belt 100 is not fixedly connected to the second hole 13, the crotch belt 100 can travel in both directions through the second hole 13, so the length of the used section of the crotch belt 100 may change. By making the second end 102 of the crotch belt 100 travel upwardly, the user can increase the length of the used section of the crotch belt 100, until downward travelling of the first end 101 of the crotch belt 100 is obstructed by the first end obstruction member 101A. In addition, when the user makes the second end 102 of the crotch belt 100 pass through different second holes 13, since distances between different second holes 13 and the first hole 15 are different, the length of a section of the crotch belt 100 between the second end 102 and the second holes 13 (i.e., the portion of the crotch belt 100 exposed on the upper surface 11A of the seat part 10) may be changed, so the length of the used section of the crotch belt 100 will be changed accordingly, thus the length of the used section of the crotch belt 100 can be adjusted, and further, for example, the height of the buckle 20 (see FIGS. 22A and 22B) arranged at the second end 102 of the crotch belt 100 in respect to the seat part 10 can be adjusted, thus that the crotch belt 100 may be suitable for children with different body sizes. Meanwhile, since different second holes 13 have different positions in the front-back direction of the seat part 10, the crotch belt 100 passing through different second holes 13 has different positions in the front-back direction of the seat part 10, which makes the crotch belt 100 more suitable for children with different body sizes.

For example, as shown in FIGS. 22A to 27, when the second end 102 of the crotch belt 100 passes through the second hole 13 far away from the first hole 15 to be exposed on the upper surface 11A of the seat part 10, since the distance between the second hole 13 far away from the first hole 15 and the first hole 15 is relatively long, when the crotch belt 100 is tightened, the length of the section of the crotch belt 100 between the second end 102 and the second hole 13 is relatively short, that is, the portion of the crotch belt 100 exposed on the upper surface 11A of the seat part 10 is relatively short, which can make the height of the buckle 20 (see FIGS. 22A and 22B) arranged at the second end 102 of the crotch belt 100 in respect to the seat part 10 relatively low. At the same time, the crotch belt 100 passing through the second hole 13 far away from the first hole 15 is located closer to the backrest part 30 in the front-back direction of the seat part 10, such that it can be suitable for children with smaller body sizes.

When the second end 102 of the crotch belt 100 passes through the second hole 13 adjacent to the first hole 15 and is exposed on the upper surface 11A of the seat part 10, since the second hole 13 adjacent to the second hole 13 adjacent to adjacent to the first hole 15 and the first hole 15 is relatively short, if the crotch belt 100 is tightened, the length of the section of the crotch belt 100 between the second end 102 and the second hole 13 is relatively long, that is, the portion of the crotch belt 100 exposed on the upper surface 11A of the seat part 10 is relatively long, which can make the height of the buckle 20 arranged at the second end 102 of the crotch belt 100 (see FIGS. 22A and 22B) in respect to the seat part 10 is relatively high. Meanwhile, the crotch belt 100 passing through the second hole 13 adjacent to the first hole 15 is positioned further away from the backrest part 30 in the front-back direction of the seat part 10, so that it can be suitable for children with larger body sizes.

It should be understood, the plurality of second holes 13 may include two or more than three second holes, so as to satisfy different practical requirements.

In the second embodiment of the crotch belt length adjusting device 100A, the crotch belt 100 can also adopt a flat broad belt. Cooperatively the first hole 15 and the plurality of second holes 13 may be formed as elongated holes, such that the crotch belt 100 can pass through these holes more smoothly.

The first hole 15 and the plurality of second holes 13 may be the same in shape and size, which may facilitate processing.

In an embodiment, as shown in FIGS. 24, 25 and 28, extending directions E of the first hole 15 and the plurality of second holes 13 are parallel to each other and parallel to the width direction W of the seat part 10.

Moreover, the first hole 15 and the plurality of second holes 13 may be arranged side by side and at intervals along the front-back direction perpendicular to the width direction W of the seat part 10.

In such configuration, when the crotch belt 100 moves from one of the second holes 13 to another second hole 13, the spacing distance between the two second holes 13 is equal to the length change value of the used section of the crotch belt 100 at two different adjusting positions, i.e., the adjustment stroke of the crotch belt 100 between two adjusting positions of the crotch belt 100.

Moreover, such configuration can make the first hole 15 closer to a front end of the seat part 10 (i.e., the end of the seat part 10 far away from the backrest part 30) than the plurality of second holes 13, and further make the first end 101 of the crotch belt 100 obstructed by the first hole 15 and exposed on the upper surface 11A of the seat part 10 closer to the front end of the seat part 10 than the second end 102 passing through one of the second holes 13 and exposed on the upper surface 11A of the seat part 10. Therefore, a hidden section 1001 (to be described later) of the crotch belt 100 between the first hole 15 and the second hole 13 is located below the lower surface 11B of the seat part 10 and arranged in the front-back direction of the seat part 10, and its arranged direction is staggered with the stress direction in which the crotch belt 100 is tightened (generally tightened upwardly) to restrain children, so as to further facilitate the user to operate the crotch belt 100.

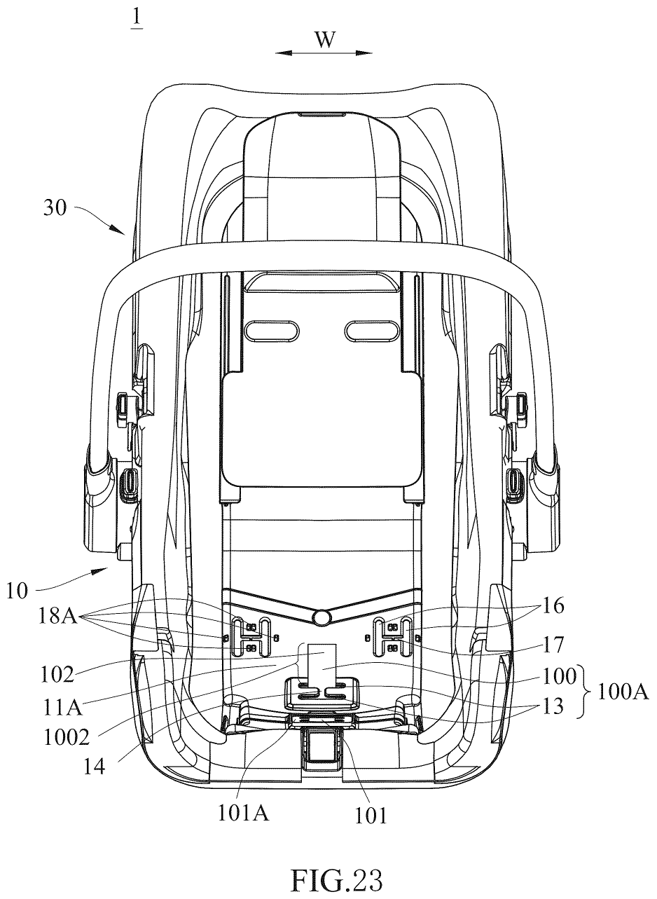

In order to facilitate the user to move the crotch belt 100 from one of the second holes 13 to another second hole 13, in the embodiment shown in FIGS. 22A to 23, the plurality of second holes 13 can be communicated with each other through the connecting hole 14 formed penetrating through the seat part 10. Thus, the user only needs to move the crotch belt 100 among the plurality of second holes 13 via the connecting hole 14, the adjustment for adjusting positions can be performed conveniently and quickly.

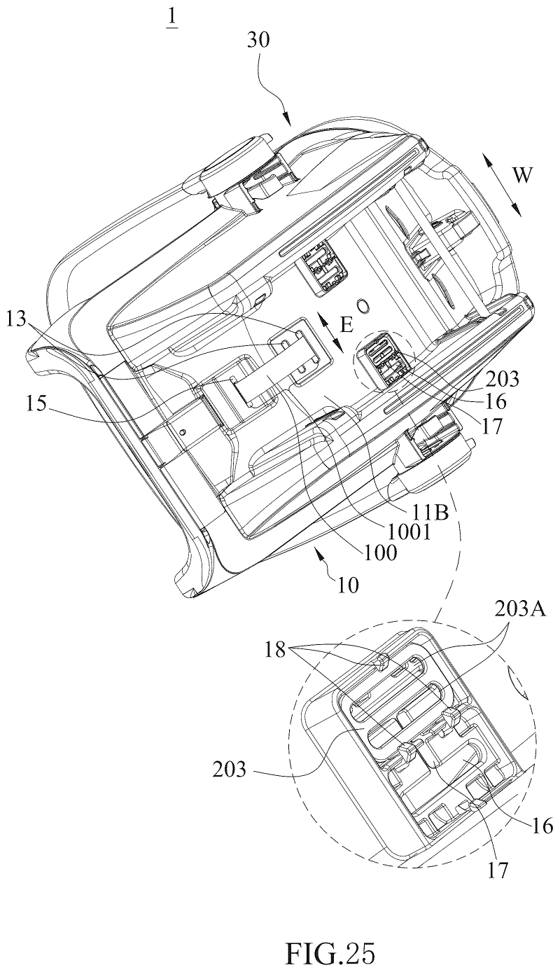

As shown in FIGS. 22A to 23, the connecting hole 14 can be similarly arranged as an elongated hole, and extend in a direction intersecting with the extending direction E of the second hole 13 (see FIGS. 24 and 25). In an embodiment, the connecting hole 14 is arranged to extend in a direction perpendicular to the extending direction E of the second hole 13. Such configuration can prevent the crotch belt 100 from accidentally sliding from one of the second holes 13 to another second hole 13 via the connecting hole 14.

Of course, the disclosure is not limited to this. The first hole 15 and the plurality of second holes 13 may be formed into holes of other shapes. Moreover, their respective extending directions may not be parallel to each other, or may not be parallel to the width direction W of the seat part 10. In addition, the first hole 15 and the plurality of second holes 13 may be formed in the seat part 10 in other arrangements.

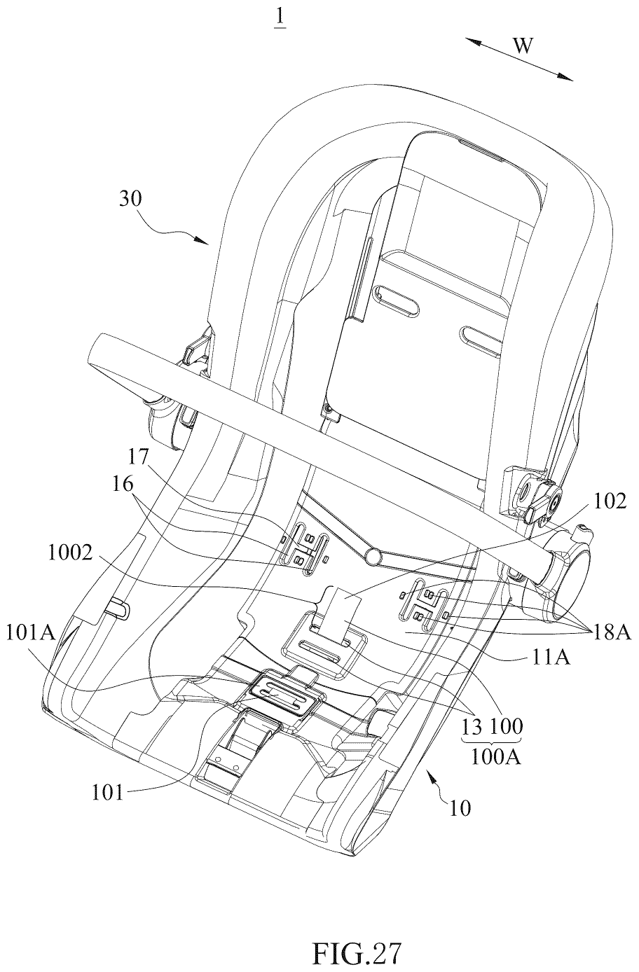

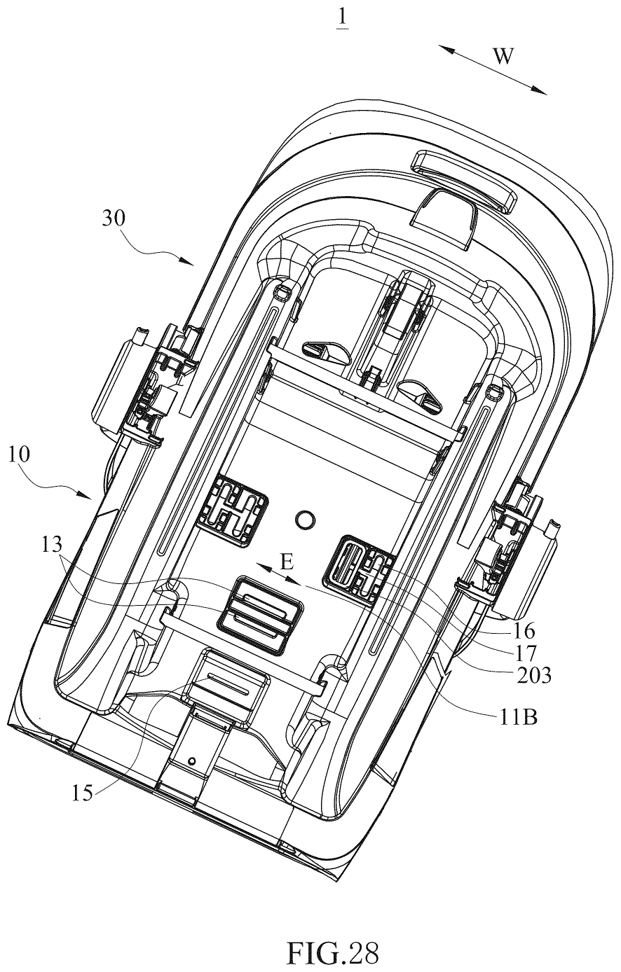

In the embodiment shown in FIGS. 27 and 28, the connecting hole 14 may not be arranged among the plurality of second holes 13.

In this embodiment, when it is required to mount or detach the crotch belt 100 to or from the seat part 10 or to adjust the length of the used section of the crotch belt 100, the first end 101 can be separated from the first end obstruction member 101A, so as to allow the first end 101 to freely pass through the first hole 15 and the second hole 13, thereby realizing that the crotch belt 100 is moved from one of the second holes 13 to another second hole 13, and after the first end 101 of the crotch belt 100A passes through another second hole 13 and reach the upper surface 11A by passing through the first hole 15 from the lower surface 11B of the seat part 10, then the first end 101 and the first end obstruction member 101A are connected together.

In order to avoid any inconvenience caused by separating and connecting of the first end 101 and the first end obstruction member 101A, the disclosure also provides an alternative, i.e., the first end obstruction member 101A may be arranged such that the sum of its thickness and the thickness of the crotch belt 100 is equal to, and preferably smaller than, the widths of the first hole 15 and the second hole 13. In the case that the sum of the thicknesses of the first end obstruction member 101A and the crotch belt 100 is equal to, and preferably smaller than, the widths of the first hole 15 and the second hole 13, the first end obstruction member 101A arranged together with the crotch belt 100 can pass through the first hole 15 along a direction in which their thickness end faces are aligned with the first hole 15, and pass through the second hole 13 along a direction in which their thickness end faces are aligned with the second hole 13, such that the first end 101 of the crotch belt 100 provided with the first end obstruction member 101A can be selectively obstructed by the first hole 15 or pass through the first hole 15 and the second hole 13 without being separated from the first end obstruction member 101A, so as to implement the adjustment for adjusting positions.

It should be understood, such a scheme that the first end obstruction member 101A in the second embodiment of the crotch belt length adjusting device 100A can be arranged as the sum of its thickness and the thickness of the crotch belt 100 is equal to, and preferably smaller than, the widths of the first hole 15 and the second hole 13 can also be applied to the first end obstruction member 101A and/or the second end obstruction member 102A, such that the first end 101 of the crotch belt 100 provided with the first end obstruction member 101A in the first embodiment can be selectively obstructed by the first hole 15 or pass through the first hole 15, and/or the second end 102 of the crotch belt 100 provided with the second end obstruction member 102A in the first embodiment can be selectively obstructed by the second hole 13 and the connecting hole 14 or pass through the second hole 13 and the connecting hole 14.

The crotch belt 100 of the crotch belt length adjusting device 100A according to the disclosure may also be described as including a hidden section 1001 located below the lower surface 11B of the seat part 10 (i.e., the section of the crotch belt 100 hidden below the seat part 10) and an exposed section 1002 located above the upper surface 11A of the seat part 10 (i.e., the section of the crotch belt 100 exposed above the seat part 10).

Specifically, the crotch belt length adjusting device 100A according to the disclosure may include a crotch belt 100 and a plurality of second holes 13 formed penetrating through the seat part 10, in which the crotch belt 100 is arranged to pass through one of the second holes 13, such that the crotch belt 100 includes a hidden section 1001 located below the lower surface 11B of the seat part 10 and an exposed section 1002 located above the upper surface 11A of the seat part 10, as shown in FIGS. 22A and 22B as well as FIGS. 24 to 26.

The crotch belt 100 has a first end 101 and a second end 102. In the case that the first end 101 of the crotch belt 100 is connected to the seat part 10, since the distance between he first end 101 of the crotch belt 100 and different second holes 13, when the crotch belt 100 passes through the different second holes 13, the used length of the hidden section 1001 will be changed (“used length of the hidden section 1001” refers to the length of the hidden section 1001 when the crotch belt 100 is tightened, and this length is corresponding to the distance between the first end 101 of the crotch belt 100 and the second hole 13 passed through by the crotch belt 100 along the lower surface 11B of the seat part 10), and correspondingly, the used length of the exposed section 1002 will also be changed (“the used length of exposed section 1002” refers to the length of the exposed section 1002 when the crotch belt 100 is tightened, and this length is corresponding to the distance between the second end 102 of the crotch belt 100 and the second hole 13 passed through by the crotch belt 100).

In the embodiments where the safety belt 200 of the child carrier 1 is provided with the connecting clasp 40, the exposed section 1002 of the crotch belt 100 may be provided with a buckle 20 which can be engaged with the connecting clasp 40.

When the crotch belt 100 passes through the second hole 13 adjacent to the first end 101, since the distance between the second hole 13 adjacent to the first end 101 and the first end 101 is relatively short, when the crotch belt 100 is tightened, the used length of the hidden section 1001 is relatively short, and correspondingly, the used length of the exposed section 1002 is relatively long, which can make the height of the buckle 20 arranged on the exposed section 1002 of the crotch belt 100 in respect to the seat part 10 is relatively high, thereby being suitable for children with larger body sizes.

When the crotch belt 100 passes through the second hole 13 far away from its first end 101, since the distance between the second hole 13 far away from the first end 101 and the first end 101 is relatively long, when the crotch belt 100 is tightened, the used length of the hidden section 1001 is relatively long, and correspondingly, the used length of the exposed section 1002 is relatively short, which can make the height of the buckle 20 arranged on the exposed section 1002 of the crotch belt 100 in respect to the seat part 10 is relatively low, thereby being suitable for children with smaller body sizes.

In an embodiment, the first end 101 of the crotch belt 100 may be an end of the hidden section 1001, and connected to the lower surface 11B of the seat part 10 of the child carrier, moreover, the second end 102 may be an end of the exposed section 1002.

In another embodiment, as shown in FIGS. 22A and 22B, the first end 101 may extend from an end of the hidden section 1001, and the second end 102 may be an end of the exposed section 1002. The crotch belt length adjusting device 100A further includes a first hole 15 formed penetrating through the seat part 10, and the first end 101 of the crotch belt 100 is exposed from the lower surface 11B of the seat part 10 through the first hole 15 to the upper surface 11A of the seat part 10.

A portion of the first end 101 exposed on the upper surface 11A may be provided with a first end obstruction member 101A. The first end obstruction member 101A may be arranged as same as described above. For example, the first end obstruction member 101A may be arranged to have a length and a width both larger than the width of the first hole 15, such that the first end obstruction member 101A cannot pass through the first hole 15 along a normal direction of the plane formed by an edge in the length direction and an edge in the width direction thereof.

In addition, the first end obstruction member 101A may be arranged such that the sum of its thickness and the thickness of the crotch belt 100 is greater than, equal to or smaller than the widths of the first hole 15 and the second hole 13, such that the first end 101 of the crotch belt 100 provided with the first end obstruction member 101A can be selectively obstructed by the first hole 15 or passed through the first hole 15 and the second hole 13 without being separated from the first end obstruction member 101A.

Moreover, arrangements of the first hole 15 and the second hole 13 may be as same as those mentioned above.

For example, the first hole 15 and the plurality of second holes 13 may both be elongated holes, and their extending directions are parallel to each other and parallel to the width direction W of the seat part 10.

For another example, the plurality of second holes 13 may be arranged side by side and at intervals along a direction perpendicular to the width direction W of the seat part 10.

For yet a further example, the a plurality of second holes 13 may be communicated with each other through a connecting hole 14 formed penetrating through the seat part 10. Moreover, the connecting hole 14 may arranged as an elongated hole and extend in a direction perpendicular to the extending direction of the second hole 13.

### Waist Belt Distance Adjusting Device

The child carrier 1 generally also has two safety belts, and each safety belt 200 can be divided into two parts: a shoulder belt and a waist belt. Referring to FIGS. 22A and 22B, when a lower end of the safety belt 200 is fixed to the seat part 10 of the child carrier 1, an upper part of the safety belt 200 is a shoulder belt, and a lower part of the safety belt 200 is a waist belt.

The distance between the lower parts (i.e., the waist belts) of the two safety belts 200 also needs to be designed in an adjustable mode, so as to be suitable for children of different body sizes, especially for premature babies.

In the embodiment shown in FIGS. 22A and 22B, the second end 102 of the crotch belt 100 is provided with a buckle 20, and a connecting clasp 40 is disposed between a first end 201 and a second end 202 of the safety belt 200 (see FIG. 22B). Through engagement of the connecting clasp 40 and the buckle 20, the second end 102 of the crotch belt 100 is connected to the safety belt 200. Among them, as shown in FIG. 22B, a part of the safety belt 200 between its second end 202 and the connecting clasp 40 forms a waist belt.

In addition, in the case that not a part of the seat belt 200 is used as a waist belt, but the waist belt is arranged separately, the waist belt distance adjusting device 200A according to the disclosure is also suitable to use.

FIGS. 22A to 29 show a child carrier 1 adopting a waist belt distance adjusting device 200A according to the disclosure. Among them, the child carrier 1 includes a seat part 10 and a backrest part 30 at an angle in respect to the seat part 10.

The waist belt distance adjusting device 200A according to the disclosure includes two safety belts 200, which have a first end 201 and a second end 202, respectively (see FIGS. 22A and 22B).

The first ends 201 of the two safety belts 200 may be respectively connected to the backrest part 30 of the child carrier 1 in various ways. For example, the backrest part 30 may be provided with a fixing structure such as a hanging hook, a hanging ring, or a hole and the like, and the first ends 201 of the safety belts 200 may be connected to the fixing structure, thereby realizing that the first ends 201 will not be separated from the backrest part 30.

In an embodiment, in order to make the used length of the safety belt 200 adjustable, the backrest part 30 may be provided with a fixed aperture (as shown in FIGS. 22A and 22B), and the first end 201 of the safety belt 200 can pass through the fixed aperture on the backrest part 30 from a front surface of the backrest part 30 to the rear surface of the backrest part 30, and be connected with an adjustment belt (not shown), such that the used length of the safety belt 200 exposed on the front surface of the backrest part 30 can be adjusted by adjusting the length of the adjustment belt.

In order to adjust the safety belt 200, as shown in FIGS. 22A to 29, the waist belt distance adjusting device 200A according to the disclosure further includes at least one set (shown as two sets) waist belt adjustment slots, and each set of the waist belt adjustment slots includes a plurality (shown as two) of waist belt adjustment slots 16, and the waist belt adjustment slots 16 are formed penetrating through the seat part 10.

As shown in FIGS. 22A and 22B, each of the second ends 202 of the two safety belts 200 respectively pass through one waist belt adjustment slot 16 in one set of waist belt adjustment slots from the upper surface 11A of the seat part 10 to the lower surface 11B of the seat part 10, and a portion of the second end 202 of one of the safety belts 200 exposed on the lower surface 11B is provided with a waist belt obstruction member 203. The waist belt obstruction member 203 is arranged to have a length and a width both larger than the width of the waist belt adjustment slot 16, such that the waist belt obstruction member 203 cannot pass through the waist belt adjustment slots 16 along a normal direction of the plane formed by an edge in the length direction and an edge in the width direction thereof, such that the waist belt obstruction member 203 can be obstructed by the waist belt adjustment slots 16 on the lower surface 11B of the seat part 10.

In this embodiment, the waist belt obstruction member 203 may be arranged such that the sum of its thickness and the crotch belt 100 is greater than, equal to or smaller than the width of the waist belt adjustment slot 16. In the case that the sum of the thicknesses of the waist belt obstruction member 203 and the safety belts 200 is greater than the width of the waist belt adjustment slot 16, since since all the overall dimensions (lengths, widths and thicknesses) of the waist belt obstruction member 203 and the safety belt 200 are greater than the width of the waist belt adjustment slots 16, the waist belt obstruction member 203 arranged together with the safety belt 200 cannot pass through the waist belt adjustment slot 16 at any angle, so the second end 202 of the safety belt 200 must be separated the waist belt obstruction member 203, then it can pass through the waist belt adjustment slot 16. In the case that the sum of the thicknesses of the waist belt obstruction member 203 and the safety belts 200 is equal to, and preferably smaller than, the width of the waist belt adjustment slot 16, the waist belt obstruction member 203 arranged together with the safety belt 200 can pass through the waist belt adjustment slot 16 along a direction in which their thickness end faces are aligned with the waist belt adjustment slot 16, such that the safety belt 200 provided with the waist belt obstruction member 203 can be selectively obstructed by the waist belt adjustment slot 16 or passed through the waist belt adjustment slot 16 without being separated from the waist belt obstruction member 203, which is helpful for connecting and disconnecting the second end 202 of the safety belts 200 with the seat part 10.

In an embodiment, the waist belt obstruction member 203 can adopt a frame buckle with a middle cross bar or a multi-layer folding structure larger than the waist belt adjustment slot 16 in size.

In addition, the waist belt obstruction member 203 located below the seat part 10 may fall down due to its own weight, and bring the second end 202 of the safety belt 200 to fall down together, resulting in the portion of the safety belt 200 falling below the seat part 10 being too long, which may affect the user to use the safety belt 200.

For this, the waist belt distance adjusting device 200A includes a waist belt limiting structure, and the waist belt limiting structure is arranged to limit movement of the waist belt obstruction member 203 in respect to the lower surface 11B of the seat part 10.

Specifically, in the embodiment shown in FIGS. 24 and 25, the waist belt limiting structure may be an obstruction member engaging structure 18 on the lower surface 11B of the seat part 10. In the embodiment shown in FIGS. 24 and 25, the obstruction member engaging structure 18 is one or more elastic fingers shaped protruded, which are arranged around the waist belt adjustment slot 16, so as to engage with edges (e.g., two opposite edges) of the waist belt obstruction member 203, thereby restricting movement of the waist belt obstruction member 203 in respect to the lower surface 11B of the seat part 10. In addition, the seat part 10 may be provided with, at a position corresponding to the obstruction member engaging structure 18, an engaging structure avoidance hole 18A formed penetrating through the seat part 10, which is used to provide a space for elastic deformation of the elastic fingers of the obstruction member engaging structure 18.

Of course, the obstruction member engaging structure 18 may take other shapes or structures as long as it can engage with the waist belt obstruction member 203 and restrict movement of the waist belt obstruction member 203 in respect to the lower surface 11B of the seat part 10.

In another embodiment, the waist belt obstruction member 203 has at least one waist belt obstruction member penetrating slot 203A (the waist belt obstruction member 203 shown in FIGS. 24 and 25 has two waist belt obstruction member penetrating slots 203A). The waist belt limiting structure can be formed by the second end 202 of the safety belts 200 sequentially passing through the waist belt adjustment slot 16 and the waist belt obstruction member 203 from the upper surface 11A of the seat part 10, and then reversibly passing through the waist belt adjustment slot 16 to return to above the upper surface 11A of the seat part 10, and being connected to other parts of the safety belt 200 above the upper surface 11A of the seat part 10.

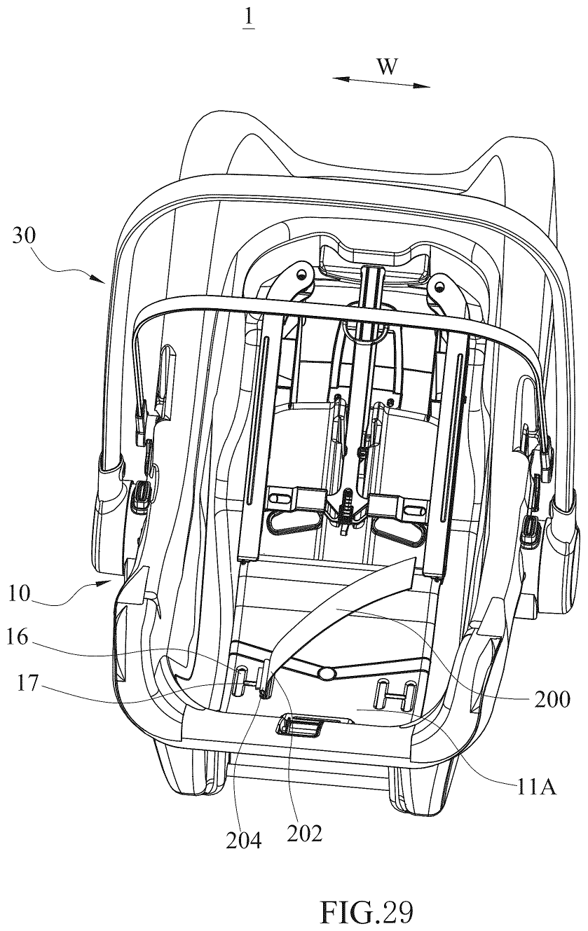

For example, in FIG. 29, the waist belt limiting structure may be formed as a half bowknot 204 with one wing part and larger than the waist belt adjustment slot 16 in size. Moreover, a free end of the half bowknot 204 is arranged to abut against the upper surface 11A of the seat part 10, thereby restricting movement of the waist belt obstruction member 203 in respect to the lower surface 11B of the seat part 10.

Of course, the waist belt limiting structure in the disclosure can take other forms as long as it can limit movement of the waist belt obstruction member 203 in respect to the lower surface 11B of the seat part 10.

In the embodiment shown in FIGS. 22A to 29, the waist belt distance adjusting device 200A includes two sets of waist belt adjustment slots, and each set of waist belt adjustment slots includes two waist belt adjustment slots 16. Moreover, FIGS. 22A and 22B show that the second ends 202 of the two safety belts 200 respectively pass through one waist belt adjustment slot 16 in a set of waist belt adjustment slots.

However, the disclosure is not limited to this.

The waist belt distance adjusting device 200A may include only one set of waist belt adjustment slots or more than two sets of waist belt adjustment slots.

In the case that the waist belt distance adjusting device 200A includes only one set of waist belt adjustment slots, the second end 202 of only one of the two safety belts 200 may pass through different waist belt adjustment slots 16 in the one set of waist belt adjustment slots. The second end 202 of the other safety belt 200 can be movably or fixedly connected to the seat part 10 in other ways. For example, the seat part 10 can be provided with a fixing structure such as a hanging hook, a hanging ring, a hole and the like, and the second end 202 of the other safety belt 200 can be connected to the fixing structure, thereby realizing that the second end 202 of the other safety belt 200 will not be separated from the seat part 10. In such case, since the second end 202 of one of the two safety belts 200 can pass through different waist belt adjustment slots 16 in a set of waist belt adjustment slots, distance adjustment between the two safety belts 200 can also be realized.

In addition, each set of waist belt adjustment slots may include three or more waist belt adjustment slots 16, such that distance adjustment range between safety belts 200 is wider.

In the embodiment shown in FIGS. 22A to 29, two sets of waist belt adjustment slots can be respectively arranged on both sides of the seat part 10 along the width direction W of the child carrier 1, i.e., the two safety belts 200 are arranged symmetrically, such that the child fixed by the safety belts 200 feels more comfortable. Of course, the two sets of waist belt adjustment slots can also be respectively arranged at other positions on the seat part 10.

In the waist belt distance adjusting device 200A according to the disclosure, the safety belts 200 can also adopt a flat broad belt. Cooperatively, the waist belt adjustment slot 16 may be formed as an elongated hole, such that the safety belts 200 can pass through the waist belt adjustment slots 16 more smoothly.

In an embodiment, as shown in FIGS. 22A to 29, the extending directions of the plurality of waist belt adjustment slots 16 are parallel to each other and perpendicular to the width direction W of the seat part 10.

Moreover, the plurality of waist belt adjustment slots 16 are arranged side by side and at intervals along the width direction W of the seat part 10.

In order to facilitate the user to move the safety belts 200 from one of the waist belt adjustment slots 16 to the other waist belt adjustment slot 16, in the embodiment shown in FIGS. 22A to 29, the plurality of waist belt adjustment slots 16 may be communicated with each other through a waist belt connecting slot 17 formed penetrating through the seat part 10. Thus, the user only needs to move the safety belts 200 among the plurality of waist belt adjustment slots 16 via the waist belt connecting slot 17, the adjustment for adjusting positions can be performed conveniently and quickly.

As shown in FIGS. 22A to 29, the waist belt connecting slot 17 can be similarly arranged as an elongated hole, and extend in a direction intersecting with the extending direction of the waist belt adjustment slot 16. In an embodiment, the waist belt connecting slot 17 is arranged to extend in a direction perpendicular to the extending direction of the waist belt adjustment slot 16. Such configuration can prevent the safety belts 200 from accidentally sliding from one of the waist belt adjustment slots 16 to another waist belt adjustment slot 16 via the waist belt connecting slot 17.

Of course, the disclosure is not limited to this. The plurality of waist belt adjustment slots 16 and the waist belt connecting slot 17 may be formed into holes of other shapes. Moreover, the extending directions of the plurality of waist belt adjustment slots 16 may not be parallel to each other, or may not be perpendicular to the width direction W of the seat part 10. In addition, the plurality of waist belt adjustment slots 16 may be formed in the seat part 10 in other arrangements.

In the waist belt distance adjusting device 200A according to the disclosure, adjustment of the safety belts 200 can also be performed at the different adjusting positions, and the plurality of waist belt adjustment slots 16 are used to realize conversion among the plurality of adjusting positions. The safety belts 200 can pass through different waist belt adjustment slots 16 in various ways, so as to achieve different changes in the distance between two safety belts 200, i.e., to achieve the adjustment for adjusting positions.

Specifically, in the embodiment where the plurality of waist belt adjustment slots 16 are communicated with each other through the waist belt connecting slot 17, as shown in FIGS. 22A to 29, the user only needs to move the safety belts 200 among the plurality of waist belt adjustment slots 16 via the waist belt connecting slot 17, and adjust the waist belt obstruction member 203 arranged at the second end 202 of the safety belt 200 from one obstructed position to another obstructed position on the lower surface 11B of the seat part 10, and then position the waist belt obstruction member 203 at another obstructed position through the waist belt limiting structure, the adjustment for adjusting positions can be conveniently and quickly achieved.

In the embodiment where the waist belt connecting slot 17 is not arranged among the waist belt adjustment slots 16, a way for the safety belt 200 to pass through different waist belt adjustment slots 16 is that the second end 202 of the safety belt 200 located below the lower surface 11B of the seat part 10 can be separated from the waist belt obstruction member 203, and then pass through the current waist belt adjustment slot 16 and retreat to above the upper surface 11A of the seat part 10; next, the second end 202 of the safety belt 200 passes through another waist belt adjustment slot 16 from the upper surface 11A of the seat part 10 to reach below the lower surface 11B of the seat part 10, and finally connects to the waist belt obstruction member 203, and position the waist belt obstruction member 203 at a corresponding obstructed position on the lower surface 11B of the seat part 10 through the waist belt limiting structure, thereby realizing the adjustment for adjusting positions.

Another more convenient way for the safety belts 200 to pass through different waist belt adjustment slots 16 is, the waist belt obstruction member 203 may be arranged such that the sum of the thicknesses of the waist belt obstruction member 203 and the safety belts 200 is equal to, and preferably smaller than, the width of the waist belt adjustment slot 16. In such case, the waist belt obstruction member 203 arranged together with the safety belts 200 can be retracted from below the lower surface 11B of the seat part 10 to above the upper surface 11A of the seat part 10 along a direction in which the thickness end faces of the waist belt obstruction member 203 and the seat part 10 are aligned with the waist belt adjustment slot 16; next, the waist belt obstruction member 203 arranged together with the safety belts 200 can pass through another waist belt adjustment slot 16 from the upper surface 11A of the seat part 10 to reach below the lower surface 11B of the seat part 10 along a direction in which the thickness end faces of the waist belt obstruction member 203 and the seat part 10 are aligned with the waist belt adjustment slot 16, and finally, the waist belt obstruction member 203 is positioned at a corresponding obstructed position on the lower surface 11B of the seat part 10 through the waist belt limiting structure, thereby realizing the adjustment for adjusting positions.

As shown in FIGS. 22A and 22B, if two safety belts 200 respectively pass through two waist belt adjustment slots 16 adjacent to the middle of the seat part 10, which is corresponding to the second ends 202 of the two safety belts 200 are respectively fixed to the waist belt adjustment slots 16 adjacent to the middle of the seat part 10. At this time, each of the waist belt obstruction members 203 arranged at the second ends 202 of the safety belts 200 can be positioned at a first obstructed position on the lower surface 11B of the seat part 10 through the waist belt limiting structure. Since the distance between the two waist belt adjustment slots 16 is relatively short, the distance between two portions of the two safety belts 200 exposed on the upper surface 11A of the seat part 10 is relatively short, which can be suitable for children with smaller body sizes.

If two safety belts 200 respectively pass through two waist belt adjustment slots 16 far from the middle of the seat part 10, which is is corresponding to the second ends 202 of the two safety belts 200 are respectively fixed to the two waist belt adjustment slots 16 far from the middle of the seat part 10. At this time, each of the waist belt obstruction members 203 arranged at the second ends 202 of the safety belts 200 can be positioned at a second obstructed position on the lower surface 11B of the seat part 10 through the waist belt limiting structure. since the distance between the two waist belt adjustment slots 16 is relatively long, the distance between the two portions of the two safety belts 200 exposed on the upper surface 11A of the seat part 10 is relatively long, which can be suitable for children with large body sizes.

Since features of the present disclosure can be embodied in various forms without departing from the characteristics of the disclosure, it should also be understood, the above embodiments are not limited to any details described above, unless otherwise specified, but should be broadly interpreted as falling within the scope defined by the appended claims, and therefore, all modifications and variations that fall within the scope and bounds of the claims or the equivalents of such ranges and bounds should be covered by the appended claims.

### LIST OF REFERENCE SIGNS

1: Child Carrier
10: Seat Part
   11A: Upper Surface
      111: Limiting Rib
   11B: Lower Surface
   12: Adjustment Hole
   13: Second Hole
      131: Second Hole at First Adjusting position
      132: Second Hole at Second Adjusting position
      133: Second Hole at Third Adjusting position
14: Connecting Hole
15: First Hole
16: Waist Belt Adjustment Slot
17: Waist Belt Connecting Slot
18: Obstruction Member engaging Structure
   18A: Engaging Structure Avoidance Hole
20: Buckle
30: Backrest Part
40: Connecting Clasp
100A: Crotch Belt Length Adjusting device
100: Crotch Belt
   1001: Hidden Section
   1002: Exposed Section
   101: First End
      101A: First End Obstruction Member
         101A1, 101A2: First End Obstruction Member Penetrating Slot
      101B: First End Stop Structure
   102: Second End
      102A: Second End Obstruction Member
         102A1, 102A2: Second End Obstruction Member Penetrating Slot
      102B: Multi-layer Folding Structure
         102B1, 102B2: Wing Part
200A: Waist belt distance adjusting device
200: Safety Belt
   201: First End
   202: Second End
   203: Waist Belt Obstruction Member
      203A: Waist Belt Obstruction Member Penetrating Slot
   204: Half Bowknot
B13: Width of Second Hole
B14: Width of Connecting Hole
E: Extending Direction of Second Hole
T: Thickness of Second End Obstruction Member
W: Width Direction

1. A crotch belt length adjusting device for a child carrier, comprising:
a crotch belt having a first end and a second end, with the first end of the crotch belt being connected to a seat part of the child carrier; and
an adjustment hole and a plurality of second holes both formed penetrating through the seat part, with the second end of the crotch belt passing through the adjustment hole from an upper surface of the seat part to a lower surface of the seat part, and then passing through one of the second holes from the lower surface to be exposed on the upper surface, and a portion of the second end exposed on the upper surface being provided with a second end obstruction member, and the second end obstruction member being arranged as unable to pass through the second hole.

2. The crotch belt length adjusting device according to claim 1, further comprising:
a first hole formed penetrating through the seat part, with the first end of the crotch belt passing through the first hole from the upper surface of the seat part to be exposed on the lower surface of the seat part, and a portion of the first end exposed on the lower surface being provided with a first end obstruction member, and the first end obstruction member being arranged as unable to pass through the first hole.

3. The crotch belt length adjusting device according to claim 1, wherein a limiting rib is formed around each of the second holes on the upper surface of the seat part, and contours of the limiting ribs are each corresponding to the shape of the second end obstruction member.

4. The crotch belt length adjusting device according to claim 1, wherein the second holes and the adjustment hole are elongated holes, and their extending directions are parallel to each other and perpendicular to a width direction of the seat part.

5. The crotch belt length adjusting device according to claim 1, wherein the second holes and the adjustment hole are arranged side by side and at intervals along a width direction of the seat part.

6. The crotch belt length adjusting device according to claim 1, wherein the second holes are communicated with each other through a connecting hole formed penetrating through the seat part, and the connecting hole is arranged as an elongated hole and extends in a direction intersecting with an extending direction of the second holes.

7. The crotch belt length adjusting device according to claim 6, wherein a portion of the second end of the crotch belt exposed on the upper surface forms a multi-layer folding structure, and the second end obstruction member is arranged on the multi-layer folding structure, such that a sum of thicknesses of the second end obstruction member and the multi-layer folding structure is greater than a width of each of the second holes or greater than a width of the connecting hole.

8. The crotch belt length adjusting device according to claim 7, wherein the multi-layer folding structure is a bowknot.

9. The crotch belt length adjusting device according to claim 7, wherein the multi-layer folding structure is provided with at least one wing part.

10. The crotch belt length adjusting device according to claim 9, wherein:
the second end obstruction member has at least one second end obstruction member penetrating slot, and
the at least one wing part is arranged to pass through the second end obstruction member penetrating slot.

11. The crotch belt length adjusting device according to claim 2, wherein a portion of the crotch belt adjacent to the first end is provided with a first end stop structure, and the first end stop structure is positioned above the upper surface of the seat part and is arranged unable to pass through the first hole.

12. The crotch belt length adjusting device according to claim 11, wherein:
the first end obstruction member has at least one first end obstruction member penetrating slot, and
the first end stop structure is formed by the first end of the crotch belt passing through the first hole and the first end obstruction member penetrating slot successively from the upper surface of the seat part, and then reversely passing through the first hole to reach above the upper surface of the seat part, and being connected with another part of the crotch belt located above the upper surface of the seat part.

13. The crotch belt length adjusting device according to claim 11, wherein the first end stop structure is formed as a half bowknot with a wing part larger than the first hole in size, and a free end of the half bowknot is arranged to abut against the upper surface of the seat part.

14. A crotch belt length adjusting device for a child carrier, comprising:
a crotch belt; and
a plurality of second holes formed penetrating through a seat part of the child carrier,
wherein the crotch belt is arranged to pass through one of the second holes, such that the crotch belt includes a hidden section located below a lower surface of the seat part and an exposed section located above an upper surface of the seat part, and a used length of the exposed section is able to be changed by passing the crotch belt through different second holes.

15. The crotch belt length adjusting device according to claim 14, wherein:
the crotch belt has a first end and a second end, the first end is an end of the hidden section and is connected to the lower surface of the seat part of the child carrier, and the second end is an end of the exposed section.

16. The crotch belt length adjusting device according to claim 14, wherein:
the crotch belt has a first end and a second end, wherein the first end extends from an end of the hidden section, and the second end is an end of the exposed section, and
the crotch belt length adjusting device further comprises a first hole formed penetrating through the seat part, wherein the first end of the crotch belt passes through the first hole from the lower surface of the seat part to be exposed on the upper surface of the seat part, wherein a portion of the first end exposed on the upper surface is provided with a first end obstruction member, and the first end obstruction member is arranged to have a length and a width both larger than a width of the first hole.

17. The crotch belt length adjusting device according to claim 14, wherein:
the first hole and the second holes are elongated holes, and their extending directions are parallel to each other and parallel to a width direction of the seat part, and
the second holes are arranged side by side and at intervals along a direction perpendicular to the width direction of the seat part.

18. The crotch belt length adjusting device according to claim 14, wherein the second holes are communicated with each other through a connecting hole formed penetrating through the seat part, and the connecting hole is arranged as an elongated hole and extends in a direction intersecting with extending directions of the second holes.

19. The crotch belt length adjusting device according to claim 16, wherein the first end obstruction member is arranged such that a sum of its thickness and a thickness of the crotch belt is equal to or smaller than the width of the first hole and equal to or smaller than a width of each of the second holes.

20-30. (canceled)
